(19) United States
(12) Patent Application Publication
(10) Pub. No.: US 2026/0194289 A1
(43) Pub. Date: Jul. 9, 2026

(54) REFRIGERATOR

(71) Applicant: SAMSUNG ELECTRONICS CO., LTD., Suwon-si (KR)

(72) Inventors: Suhyeong LIM, Suwon-si (KR); Donghyeon KWAK, Suwon-si (KR); Jaejin LEE, Suwon-si (KR); Hojune JEON, Suwon-si (KR)

(73) Assignee: SAMSUNG ELECTRONICS CO., LTD., Suwon-si (KR)

(21) Appl. No.: 19/552,782

(22) Filed: Feb. 27, 2026

Related U.S. Application Data
(63) Continuation of application No. PCT/KR2024/012050, filed on Aug. 13, 2024.

(30) Foreign Application Priority Data
Sep. 1, 2023 (KR) 10-2023-0116469
Nov. 8, 2023 (KR) 10-2023-0154030

(51) Int. Cl. F25D 23/02; E05F 1/12

(52) U.S. Cl. CPC F25D 23/028; E05F 1/1207; F25D 23/025; F25D 2323/021; F25D 2323/023; F25D 2323/024

(57) ABSTRACT

A refrigerator may include: a main body including a storage compartment; an inner door rotatably provided on a front side of the main body, the inner door including an opening; an outer door rotatably provided on a front side of the inner door, the outer door configured to open or close the opening; a hinge connecting the outer door and the inner door, the hinge configured to rotatably support the outer door; and a door elastic member between the hinge and the outer door, the door elastic member configured to elastically bias the outer door in an opening direction of the outer door.

### CROSS-REFERENCE TO RELATED APPLICATIONS

This application is a bypass continuation of International Patent Application No. PCT/KR2024/012050, filed on August 13, 2024, which claims priority to Korean Patent Application No. 10-2023-0116469, filed in the Korean Intellectual Property Office on September 1, 2023, and Korean Patent Application No. 10-2023-0154030, filed in the Korean Intellectual Property Office on November 8, 2023, the disclosures of which are hereby incorporated by reference in their entireties.

### BACKGROUND

### Field

The disclosure relates to a refrigerator, and more particularly, to a structure in which a door of the refrigerator may be locked or unlocked, and in which the door may be automatically opened upon unlocking of the door.

### Description of Related Art

A refrigerator may be an appliance for keeping food fresh, including a main body having a storage compartment, a cold air supply device for supplying cold air to the storage compartment, and a door for opening or closing the storage compartment.

The door of the refrigerator may be provided to open or close the storage compartment while rotating about a rotation axis. The refrigerator may be provided with a locking structure capable of unlocking or locking the door to keep the door in a closed state.

In addition, the refrigerator may be provided with a structure capable of automatically opening the door.

The door of the refrigerator may include an inner door having an opening and rotatably coupled to the main body, and an outer door rotatably provided with respect to the inner door to open or close the opening of the inner door.

### SUMMARY

An aspect of the disclosure provides a refrigerator having a locking device capable of locking or unlocking an outer door of the refrigerator.

An aspect of the disclosure provides a refrigerator having a door auto-opening structure capable of automatically opening an outer door of the refrigerator.

An aspect of the disclosure provides a refrigerator capable of adjusting an opening angle or an opening force of an outer door.

Aspects of embodiments of the disclosure are not limited to the aspects mentioned above, and other unmentioned aspects of the disclosure will be clearly understood by those skilled in the art from the description below.

According to some embodiments of the disclosure, a refrigerator may include: a main body including a storage compartment; an inner door rotatably provided on a front side of the main body, the inner door including an opening; an outer door rotatably provided on a front side of the inner door, the outer door configured to open or close the opening; a hinge connecting the outer door and the inner door, the hinge configured to rotatably support the outer door; and a door elastic member between the hinge and the outer door, the door elastic member configured to elastically bias the outer door in an opening direction of the outer door.

According to some embodiments of the disclosure, the door elastic member may include: a first coupling portion at one end of the door elastic member, the first coupling portion connected to the hinge; and a second coupling portion at an opposite end of the door elastic member, the second coupling portion connected to the outer door.

According to some embodiments of the disclosure, the hinge may include a first support hole that is configured to receive the first coupling portion, and the outer door may include at least one second support hole that is configured to receive the second coupling portion.

According to some embodiments of the disclosure, the at least one second support hole may be a plurality of second support holes, and the plurality of second support holes may be spaced apart from each other such that an elastic force of the door elastic member is adjusted depending on which of the plurality of second support holes the second coupling portion is inserted into.

According to some embodiments of the disclosure, the door elastic member may include a torsion spring , the torsion spring including: a coiled portion; a first spring arm extending from one end of the coiled portion; and a second spring arm extending from an opposite end of the coiled portion.

According to some embodiments of the disclosure, an angle between the first spring arm and the second spring arm may be configured to be adjusted depending on which of the plurality of second support holes the second coupling portion is inserted into.

According to some embodiments of the disclosure, the first coupling portion may extend at a first angle from the first spring arm at an end of the first spring arm, and the second coupling portion may extend at a second angle from the second spring arm at an end of the second spring arm.

According to some embodiments of the disclosure, the first coupling portion may extend in a first direction at the end of the first spring arm, and the second coupling portion may extend in a second direction opposite to the first direction at the end of the second spring arm.

According to some embodiments of the disclosure, the hinge may include: a hinge bracket including: a door coupling portion connected to the inner door; and a hinge arm extending from the door coupling portion toward the outer door, a hinge pin at one end of the hinge arm, wherein the hinge pin forms an outer door rotation axis of the outer door, and a hinge cover connected to the hinge bracket and covering the hinge bracket.

According to some embodiments of the disclosure, the first support hole may be in the hinge cover.

According to some embodiments of the disclosure, the refrigerator may further include a reed switch configured to detect opening or closing of the outer door, wherein the hinge cover includes a switch mounting portion on which the reed switch is mounted.

According to some embodiments of the disclosure, the outer door may include a hinge receiving portion that is recessed in a surface of the outer door, the hinge receiving portion configured to receive the hinge, and the at least one second support hole may be in an inner surface of the hinge receiving portion.

According to some embodiments of the disclosure, the refrigerator may further include a magnet on an upper side of the hinge receiving portion, the magnet configured to interact with the reed switch.

According to some embodiments of the disclosure, the refrigerator may further include an elastic member cover that is connected to the hinge receiving portion and covers the door elastic member.

According to some embodiments of the disclosure, the refrigerator may further include a locking device configured to lock or unlock the outer door.

According to some embodiments of the disclosure, a refrigerator may include: a main body including a storage compartment; an inner door rotatably provided on a front side of the main body, the inner door including an opening; an outer door rotatably provided on a front side of the inner door, the outer door configured to open or close the opening; a hinge connecting the outer door to the inner door, the hinge configured to rotatably support the outer door; a locking device configured to lock or unlock the outer door; and a door elastic member configured to accumulate an elastic force in a case where the outer door is locked and to open the outer door through the elastic force, which is accumulated, in a case where the outer door is unlocked.

According to some embodiments of the disclosure, the door elastic member may include: a first coupling portion at one end of the door elastic member, the first coupling portion connected to the hinge; and a second coupling portion at an opposite end of the door elastic member, the second coupling portion connected to the outer door.

According to some embodiments of the disclosure, the hinge may include a first support hole that is configured to receive the first coupling portion, and the outer door may include a plurality of second support holes that are configured to receive the second coupling portion, the plurality of second support holes spaced apart from each other such that the elastic force of the door elastic member is configured to be adjusted depending on which of the plurality of second support holes the second coupling portion is inserted into.

According to some embodiments of the disclosure, the door elastic member may include a torsion spring, the torsion spring including: a coiled portion; a first spring arm extending from one end of the coiled portion; and a second spring arm extending from an opposite end of the coiled portion.

According to some embodiments of the disclosure, an angle between the first spring arm and the second spring arm is adjustable depending on which of the plurality of second support holes the second coupling portion is inserted into.

According to various embodiments of the disclosure, upon unlocking the outer door through the locking device, the outer door may be automatically opened without any further operation.

According to various embodiments of the disclosure, the opening angle or the opening force of the outer door may be adjusted.

The effects of embodiments of the disclosure are not limited to those mentioned above, and other unmentioned effects of embodiments of the present disclosure will be apparent to those of skilled in the art from the following description.

### BRIEF DESCRIPTION OF DRAWINGS

FIG. 1 is a view illustrating a refrigerator according to an embodiment of the disclosure, showing a state in which all doors are closed.

FIG. 2 is a view illustrating the refrigerator according to an embodiment of the disclosure, showing a state in which one outer door is opened.

FIG. 3 is a view illustrating the refrigerator according to an embodiment of the disclosure, showing a state in which all doors are opened.

FIG. 4 is a view illustrating an inner door and an outer door according to an embodiment of the disclosure.

FIG. 5 is an exploded view of the outer door according to an embodiment of the disclosure.

FIG. 6 is a cross-sectional view of the outer door according to an embodiment of the disclosure, taken along a line Ι-Ι of FIG. 4.

FIG. 7 is a cross-sectional view of the outer door according to an embodiment of the disclosure, taken along a line II-II of FIG. 4.

FIG. 8 is a view illustrating a locking device according to an embodiment of the disclosure.

FIG. 9 is a view illustrating a coupling structure of a lever and a connecting rod according to an embodiment of the disclosure.

FIG. 10 is an exploded view of a part of the locking device according to an embodiment of the disclosure.

FIG. 11 is a view illustrating a housing cover separated from a housing of the locking device according to an embodiment of the disclosure.

FIG. 12 is a view illustrating a coupling structure of a connector and a latch according to an embodiment of the disclosure.

FIG. 13 is a perspective view illustrating the connector and the latch according to an embodiment of the disclosure.

FIG. 14 is another perspective view illustrating the connector and the latch according to an embodiment of the disclosure.

FIG. 15 is a view illustrating a state in which the connector is in a default position and the latch is in an engaged position, according to an embodiment of the disclosure.

FIG. 16 is a cross-sectional view taken along a line III-III of FIG. 15.

FIG. 17 is a view illustrating a state in which the connector is in an advanced position and the latch is in a disengaged position, according to an embodiment of the disclosure.

FIG. 18 is a cross-sectional view taken along a line IV-IV of FIG. 15.

FIG. 19 is a view illustrating a coupling structure of an inner door, an outer door, and a hinge, according to an embodiment of the disclosure.

FIG. 20 is an exploded view of the hinge according to an embodiment of the disclosure.

FIG. 21 is a view illustrating a coupling structure of a door elastic member according to an embodiment of the disclosure.

FIG. 22 is another view illustrating the coupling structure of the door elastic member according to an embodiment of the disclosure.

FIG. 23 is a view illustrating a structure for adjusting an elastic force of the door elastic member according to an embodiment of the disclosure, showing the door elastic member in a state where a first angle is between a first spring arm and a second spring arm.

FIG. 24 is a view illustrating a structure for adjusting an elastic force of the door elastic member according to an embodiment of the disclosure, showing the door elastic member in a state where a second angle is between the first spring arm and the second spring arm.

FIG. 25 is a view illustrating a structure for adjusting an elastic force of the door elastic member according to an embodiment of the disclosure, showing the door elastic member in a state where a third angle is between the first spring arm and the second spring arm.

### DETAILED DESCRIPTION

The various example embodiments of the disclosure and terms used in the disclosure are not intended to limit the disclosure to specific embodiments, and the disclosure should be understood to include various modifications, equivalents, and substitutions of the corresponding example embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B,” “at least one of A and B,” “at least one of A or B,” “A, B or C,” “at least one of A, B and C,” and “at least one of A, B, or C” may include any one or all possible combinations of the items listed together in the corresponding phrase among the phrases.

As used herein, the term “and/or” includes any and all combinations of one or more of the associated listed items.

Terms such as “first,” “second,” “primary,” and “secondary” may be used simply to distinguish an element from other elements, without limiting the element in other aspects (e.g., importance or order).

Further, as used in the disclosure, the terms “front,” “rear,” “top,” “bottom,” “side,” “left,” “right,” “upper,” “lower,” and the like are defined with reference to the drawings, and are not intended to limit the shape and position of any element.

It will be understood that when the terms “includes,” “comprises,” “including,” and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to,” “coupled to,” “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

A refrigerator according to an embodiment of the disclosure may include a main body.

The main body may include insulation. The insulation may insulate an inside of the storage compartment from an outside of the storage compartment to maintain inside temperature of the storage compartment at appropriate temperature without being influenced by an external environment of the storage compartment. According to an embodiment of the disclosure, the insulation may include a foaming insulation such as polyurethane form. According to an embodiment, the insulation may include vacuum insulation in addition to foam insulation, or the insulation may include vacuum insulation only instead of foam insulation.

The storage compartment may store a variety of items, such as food, medicines, cosmetics, and the like, and the storage compartment may be configured to be open on at least one side for insertion and removal of the items.

The refrigerator may include one or more storage compartments. In a case in which two or more storage compartments are formed in the refrigerator, the respective storage compartments may have different purposes of use, and may be maintained at different temperatures. To this end, the respective storage compartments may be partitioned by a partition wall including an insulation.

The storage compartment may be maintained within an appropriate temperature range according to a purpose of use, and may include a “refrigerating compartment,” a “freezing compartment,” and a “temperature conversion compartment” according to purposes of use and/or temperature ranges. The refrigerating compartment may be maintained at an appropriate temperature to keep food refrigerating, and the freezing compartment may be maintained at an appropriate temperature to keep food frozen. The “refrigerating” may be keeping food cold without freezing the food, and for example, the refrigerating compartment may be maintained within a range of 0 degrees Celsius to 7 degrees Celsius. The “freezing” may be freezing food or keeping food frozen, and for example, the freezing compartment may be maintained within a range of -20 degrees Celsius to -1 degrees Celsius. The temperature conversion compartment may be used as either a refrigerating compartment or a freezing compartment according to or regardless of a user’s selection.

The storage compartment may also be referred to by various terms, such as “vegetable compartment,” “freshness compartment,” “cooling compartment,” and “ice-making compartment,” in addition to “refrigerating compartment,” “freezing compartment,” and “temperature conversion compartment,” and the terms, such as “refrigerating compartment,” “freezing compartment,” “temperature conversion compartment,” etc., as used below are to be understood as representing storage compartments having the corresponding purposes of use and the corresponding temperature ranges.

The refrigerator according to an embodiment of the disclosure may include at least one door configured to open or close the open side of the storage compartment. The respective doors may be provided to open and close one or more storage compartments, or a single door may be provided to open and close a plurality of storage compartments. The door may be rotatably or slidably mounted to the front of the main body.

The door may seal the storage compartment in a closed state. The door, like the main body, may include insulation to insulate the storage compartment in a closed state.

According to an embodiment, the door may include an outer door plate forming the front surface of the door, an inner door plate forming the rear surface of the door and facing the storage compartment, an upper cap, a lower cap, and a door insulation provided therein.

A gasket may be provided on the edge of the inner door plate to seal the storage compartment by coming into close contact with the front surface of the main body when the door is closed. The inner door plate may include a dyke that protrudes rearward to allow a door basket for storing items to be fitted.

According to an embodiment, the door may include a door body and a front panel that is detachably coupled to the front of the door body and forming the front surface of the door. The door body may include an outer door plate forming the front surface of the door body, an inner door plate forming the rear surface of the door body and facing the storage compartment, an upper cap, a lower cap, and a door insulator provided therein.

The refrigerator may be classified as French Door Type, Side-by-side Type, Bottom Mounted Freezer (BMF), Top Mounted Freezer (TMF), or Single Door Refrigerator according to the arrangement of the doors and the storage compartments.

The refrigerator according to an embodiment of the disclosure may include a cold air supply device for supplying cold air to the storage compartment.

The cold air supply device may include a machine, an apparatus, an electronic device, and/or a combination system thereof, capable of generating cold air and guiding the cold air to cool the storage compartment.

According to an embodiment of the disclosure, the cold air supply device may generate cold air through a cooling cycle including compression, condensation, expansion, and evaporation processes of refrigerants. To this end, the cold air supply device may include a refrigeration cycle device having a compressor, a condenser, an expander, and an evaporator to drive the refrigeration cycle. According to an embodiment of the disclosure, the cold air supply device may include a semiconductor, such as a thermoelectric element. The thermoelectric element may cool the storage compartment by heating and cooling actions through the Peltier effect.

The refrigerator according to an embodiment of the disclosure may include a machine compartment in which at least some components belonging to the cold air supply device are installed.

The machine compartment may be partitioned and insulated from the storage compartment to prevent heat generated by the components installed in the machine compartment from being transferred to the storage compartment. To dissipate heat from the components installed in the machine compartment, the machine compartment may communicate with outside of the main body.

The refrigerator according to an embodiment of the disclosure may include a dispenser provided on the door to provide water and/or ice. The dispenser may be provided on the door to allow access by the user without opening the door.

The refrigerator according to an embodiment of the disclosure may include an ice-making device that produces ice. The ice-making device may include an ice-making tray that stores water, an ice-moving device that separates ice from the ice-making tray, and an ice-bucket that stores ice produced in the ice-making tray.

The refrigerator according to an embodiment of the disclosure may include a controller for controlling the refrigerator.

The controller may include a memory for storing and/or recording data and/or programs for controlling the refrigerator, and at least one processor for outputting control signals for controlling the cold air supply device, etc., in accordance with the programs and/or data stored in the memory.

The memory may store or record various information, data, instructions, programs, and the like for operation of the refrigerator. The memory may store temporary data generated while generating control signals for controlling components included in the refrigerator. The memory may include at least one from among a volatile memory and a non-volatile memory, or a combination thereof.

The at least one processor may control the overall operation of the refrigerator. The at least one processor may control the components of the refrigerator by executing programs stored in memory. The at least one processor may include a separate neural processing unit (NPU) that performs an artificial intelligence (AI) model operation. In addition, the at least one processor may include a central processing unit (CPU), a graphics processor (GPU), and the like. The at least one processor may generate a control signal to control the operation of the cold air supply device. For example, the at least one processor may receive temperature information of the storage compartment from a temperature sensor and generate a cooling control signal to control an operation of the cold air supply device based on the temperature information of the storage compartment.

Furthermore, the at least one processor may process a user input of a user interface and control an operation of the user interface in accordance with the programs and/or data memorized/stored in the memory. The user interface may be provided with an input interface and an output interface. The at least one processor may receive the user input from the user interface. In addition, the at least one processor may transmit a display control signal and image data for displaying an image on the user interface to the user interface in response to the user input.

The at least one processor and memory may be provided integrally or may be provided separately. The at least one processor may include one or more processors. For example, the at least one processor may include a main processor and at least one sub-processor. The memory may include one or more memories.

The refrigerator according to an embodiment of the disclosure may include at least one processor and a memory for controlling all of the components included in the refrigerator, and may include a plurality of processors and a plurality of memories for individually controlling the components of the refrigerator. For example, the refrigerator may include at least one processor and a memory for controlling the operation of the cold air supply device in accordance with to an output of the temperature sensor. In addition, the refrigerator may be separately provided with at least one processor and a memory for controlling the operation of the user interface in accordance with the user input.

A communication module may communicate with external devices, such as servers, mobile devices, and other home appliances via a nearby access point (AP). The AP may connect a local area network (LAN) to which a refrigerator or a user device is connected to a wide area network (WAN) to which a server is connected. The refrigerator or the user device may be connected to the server via the WAN.

The input interface may include keys, a touch screen, a microphone, and the like. The input interface may receive the user input and pass the received user input to the at least one processor.

The output interface may include a display, a speaker, and the like. The output interface may output various notifications, messages, information, and the like generated by the at least one processor.

Hereinafter, non-limiting example embodiments according to the disclosure will be described in detail with reference to the accompanying drawings.

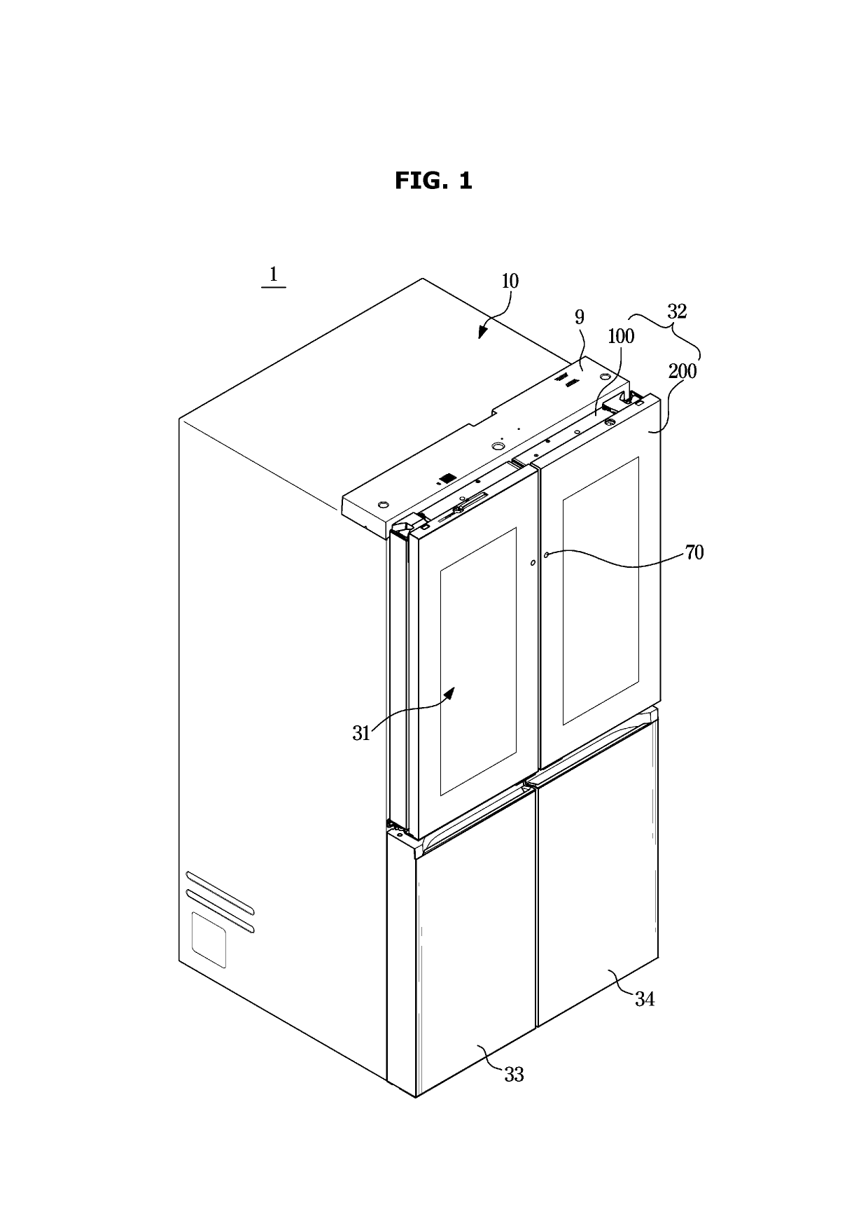

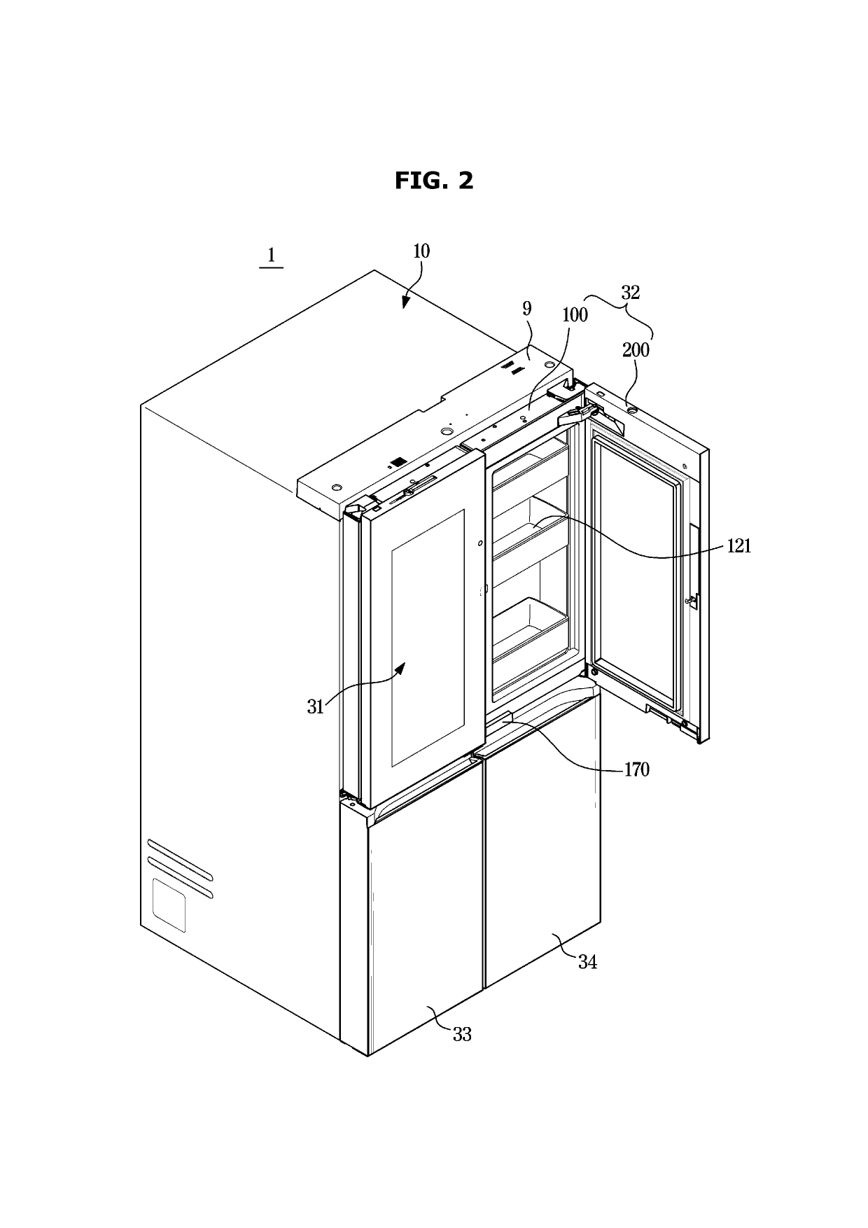

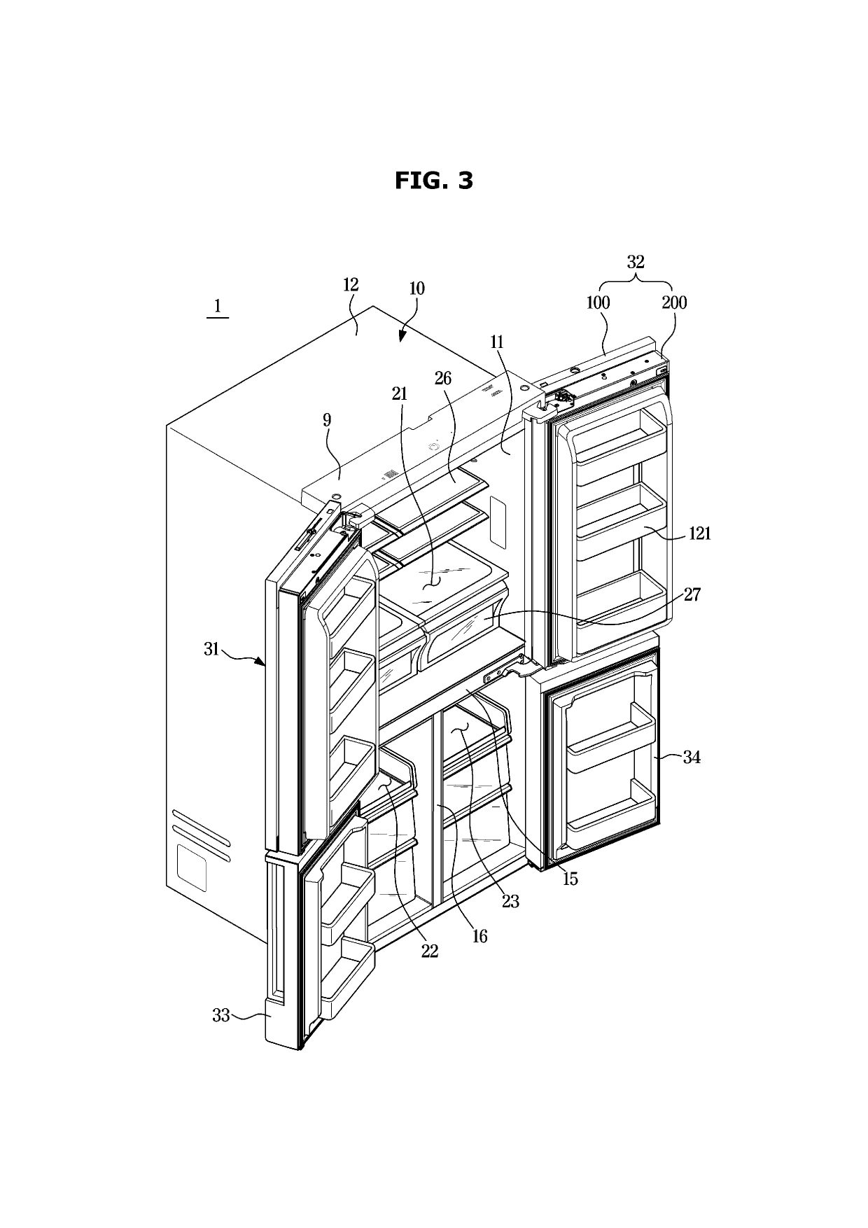

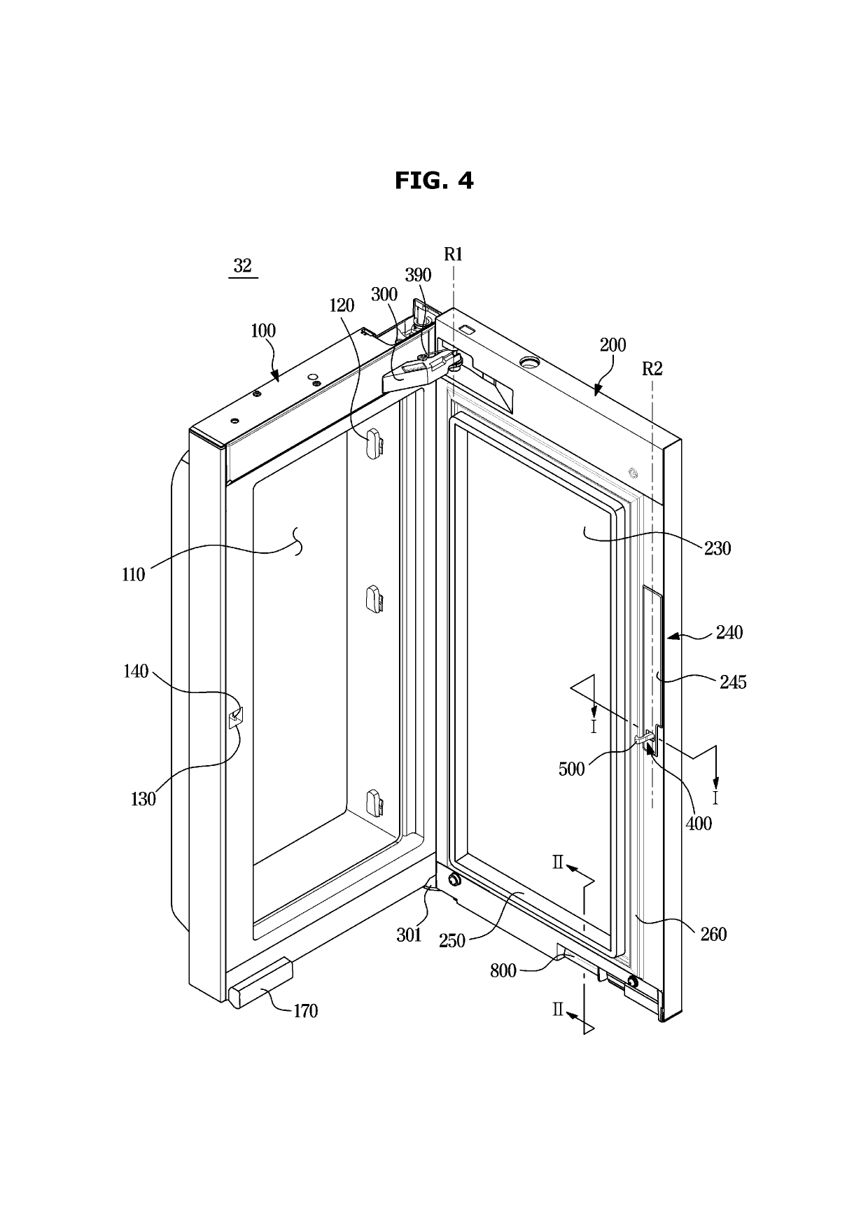

FIG. 1 is a view illustrating a refrigerator according to an embodiment of the disclosure, showing a state in which all doors are closed. FIG. 2 is a view illustrating the refrigerator according to an embodiment of the disclosure, showing a state in which one outer door is opened. FIG. 3 is a view illustrating the refrigerator according to an embodiment of the disclosure, showing a state in which all doors are opened. FIG. 4 is a view illustrating an inner door and an outer door according to an embodiment of the disclosure.

Referring to FIGS. 1 to 4, a refrigerator 1 may include a main body 10, storage compartments (e.g., an upper storage compartment 21, a left lower storage compartment 22, and a right lower storage compartment 23) formed inside the main body 10, doors 31, 32, 33, and 34 for opening or closing the storage compartments (e.g., the upper storage compartment 21, the left lower storage compartment 22, and the right lower storage compartment 23), and a cold air supply device for supplying cold air to the storage compartments (e.g., the upper storage compartment 21, the left lower storage compartment 22, and the right lower storage compartment 23).

The main body 10 may include an inner case 11 forming the storage compartments (e.g., the upper storage compartment 21, the left lower storage compartment 22, and the right lower storage compartment 23), an outer case 12 coupled to an outer side of the inner case 11 to form an exterior, and an insulation provided between the inner case 11 and the outer case 12 to thermally insulate the storage compartments (e.g., the upper storage compartment 21, the left lower storage compartment 22, and the right lower storage compartment 23). A top cover 9, which may cover an upper hinge of an inner door 100, may be provided on an upper surface of the main body 10.

The storage compartments (e.g., the upper storage compartment 21, the left lower storage compartment 22, and the right lower storage compartment 23) may be partitioned into a plurality of sections by a horizontal partition wall 15 and a vertical partition wall 16. The storage compartments may be partitioned into an upper storage compartment 21 and lower storage compartments by the horizontal partition wall 15, and the lower storage compartments may be partitioned into a left lower storage compartment 22 and a right lower storage compartment 23 by the vertical partition wall 16.

The upper storage compartment 21 may be used as a refrigerating compartment, and the lower storage compartments (e.g., the left lower storage compartment 22 and the right lower storage compartment 23) may be used as a freezing compartment. However, the partitioning and use of the storage compartments (e.g., the upper storage compartment 21, the left lower storage compartment 22, and the right lower storage compartment 23) as described above is only an example and is not limited thereto.

In addition, unlike the present embodiment, the refrigerator may be a side by side (SBS) type in which a storage compartment is partitioned into a left and right side by a vertical partition wall, a French door refrigerator (FDR) type in which a storage compartment is partitioned into an upper refrigerating compartment and a lower refrigerating compartment by a horizontal partition wall, or a one-door type having one storage compartment and one door.

Shelves 26 and storage containers 27 may be provided inside the storage compartments (e.g., the upper storage compartment 21, the left lower storage compartment 22, and the right lower storage compartment 23).

The cold air supply device may generate cold air using a cooling circulation cycle that compresses, condenses, expands, and evaporates a refrigerant, and supply the generated cold air to the storage compartments (e.g., the upper storage compartment 21, the left lower storage compartment 22, and the right lower storage compartment 23).

The upper storage compartment 21 may be opened or closed by a pair of doors 31 and 32. The doors 31 and 32 may be rotatably coupled to the main body 10. One of the pair of doors 31 and 32 may be provided with a rotating bar that prevents cold air from the storage compartment 21 from escaping between the pair of doors 31 and 32 when the pair of doors 31 and 32 are closed.

The left lower storage compartment 22 may be opened or closed by a door 33, and the door 33 may be rotatably coupled to the main body 10. The right lower storage compartment 23 may be opened or closed by a door 34, and the door 34 may be rotatably coupled to the main body 10.

At least one of the doors 31, 32, 33, and 34 may be configured as a double door having an inner door and an outer door. In an example, an upper right door (e.g., the door 32) may include the inner door 100 and an outer door 200.

The inner door 100 may be rotatably coupled to the main body 10 via a hinge. The inner door 100 may have an opening 110. The opening 110 may be formed to penetrate a central portion of the inner door 100 in a front-to-rear direction. Thus, the opening 110 may be in communication with the storage compartment 21. A door basket 121 for receiving items may be mounted in the opening 110. To this end, a basket support 120 may protrude on a surface of the inner door 100 facing the opening 110 to allow the door basket 121 to be mounted. The inner door 100 may be provided with a handle 170 for a user to grasp and open the inner door 100.

The outer door 200 may be configured to open or close the opening 110 of the inner door 100. When the outer door 200 is opened, the opening 110 of the inner door 100 and the door basket 121 provided in the opening 110 may be accessible. In other words, the door basket 121 may be accessible by opening the outer door 200 without the need to open the inner door 100.

The outer door 200 may be rotatably coupled to the inner door 100 via an upper hinge 300 and a lower hinge 301.

An outer door rotation axis R1 may be aligned parallel to an inner door rotation axis, and the outer door 200 may rotate in the same direction as the inner door 100. The outer door 200 may have a size corresponding to the size of the inner door 100. The outer door 200 may cover the entire area of the inner door 100.

The refrigerator 1 may include a locking device 400 capable of locking or unlocking the outer door 200. When the outer door 200 is in a locked state by the locking device 400, the outer door 200 may be unable to be opened, and when the outer door 200 is unlocked by the locking device 400, the outer door 200 may be able to be opened.

The locking device 400 may be provided on the outer door 200. The locking device 400 may include a latch 500 rotatably arranged about a latch rotation axis R2. The latch rotation axis R2 may be formed parallel to the outer door rotation axis R1.

The inner door 100 may be provided with a fixing portion 140 to which the latch 500 is coupled or uncoupled. The fixing portion 140 may be provided on a front surface of the inner door 100. A recessed slot 130 may be formed on the front surface of the inner door 100, and the fixing portion 140 may be formed in the interior of the recessed slot 130.

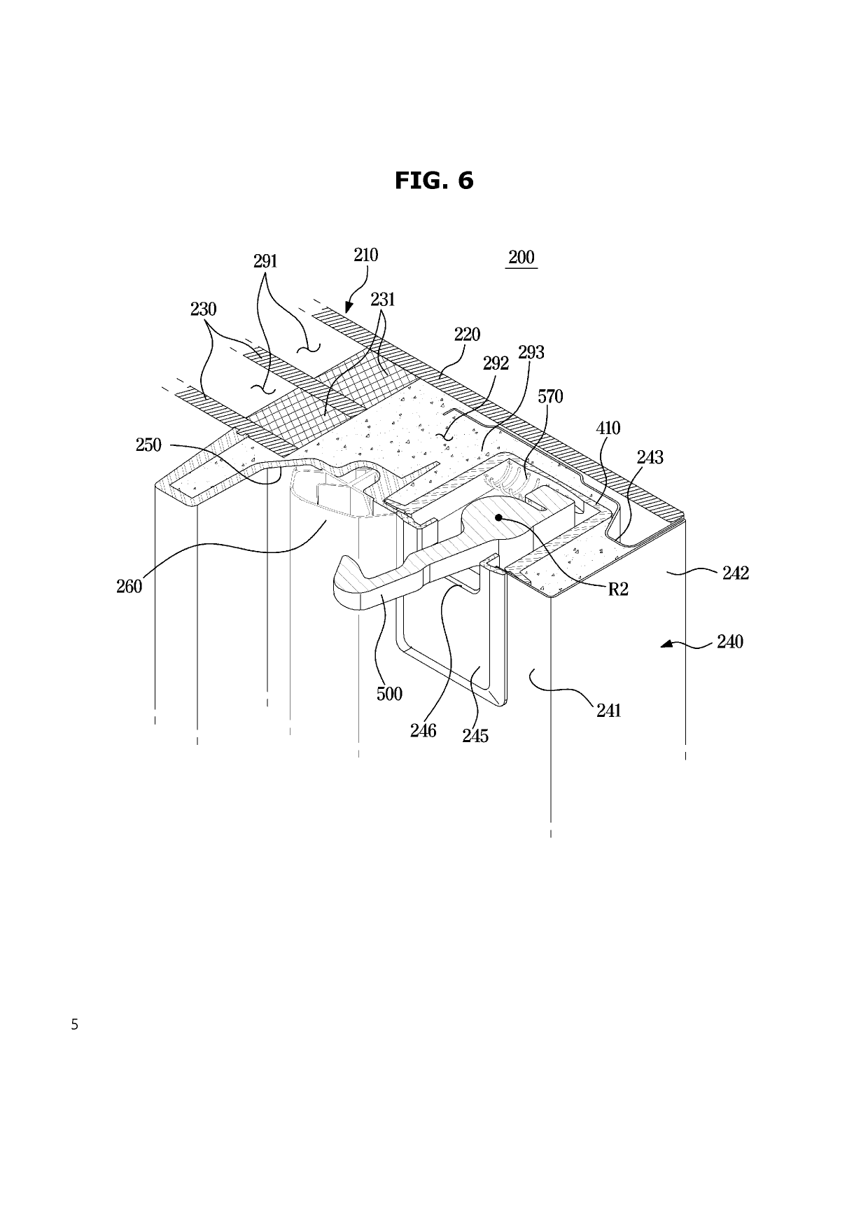

The latch 500 may include a hook shape that is coupled to the fixing portion 140. The latch 500 may be configured to be rotatable about the latch rotation axis R2 (see FIGS. 4 and 6) between an engaged position where the latch is engaged with the fixing portion 140 and a disengaged position where the latch is disengaged from the fixing portion 140.

When the latch 500 is in the engaged position (i.e., when the latch 500 and the fixing portion 140 are engaged) the outer door 200 is in a locked state and the outer door 200 may not be opened.

When the latch 500 is in the disengaged position (i.e., when the latch 500 and the fixing portion 140 are disengaged) the outer door 200 is in an unlocked state and the outer door 200 may be openable.

According to an embodiment of the disclosure, once the outer door 200 is in an unlocked state, the outer door 200 may automatically open without any further operation. To this end, the refrigerator 1 may include a door elastic member 390 (see FIG. 4) that elastically biases the outer door 200 in an opening direction.

The door elastic member 390 may be provided between the upper hinge 300 and the outer door 200. The door elastic member 390 may accumulate an elastic force when the outer door 200 is closed. When the outer door 200 is unlocked, the outer door 200 may be opened by the elastic force accumulated in the door elastic member 390.

According to an embodiment of the disclosure, the locking device 400 may be manually and automatically actuated. In other words, the latch 500 may be rotated by a physical force (i.e., operating force) from a user, or the latch 500 may be rotated by a driving force generated from a separate drive source. To this end, the locking device 400 may include a manual unlocking portion and an automatic unlocking portion. However, in some embodiments, one from among the manual unlocking portion and the automatic unlocking portion may be omitted.

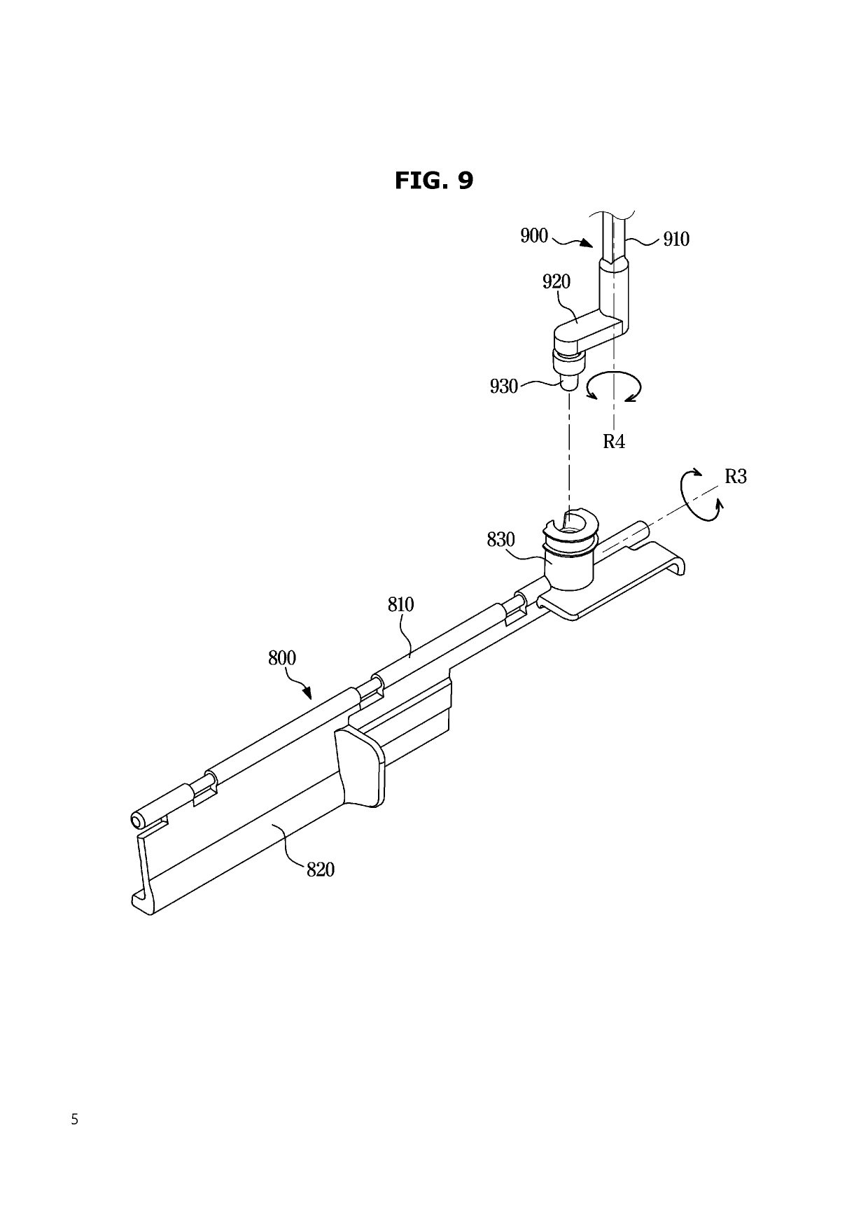

The manual unlocking portion may include a lever 800 that is configured to be manually operated by a user by contact. The lever 800 may be configured to be rotatable about a lever rotation axis R3 (see FIG. 9). The user’s operating force applied to the lever 800 may be transmitted to the latch 500, causing the latch 500 to rotate. Instead of rotating the lever 800 about the lever rotation axis R3, the user may also open the outer door 200 by pulling the lever 800 in a horizontal direction. In such an aspect, the lever 800 may be referred to as a handle of the outer door 200. The lever 800 may be provided on a lower portion of the outer door 200.

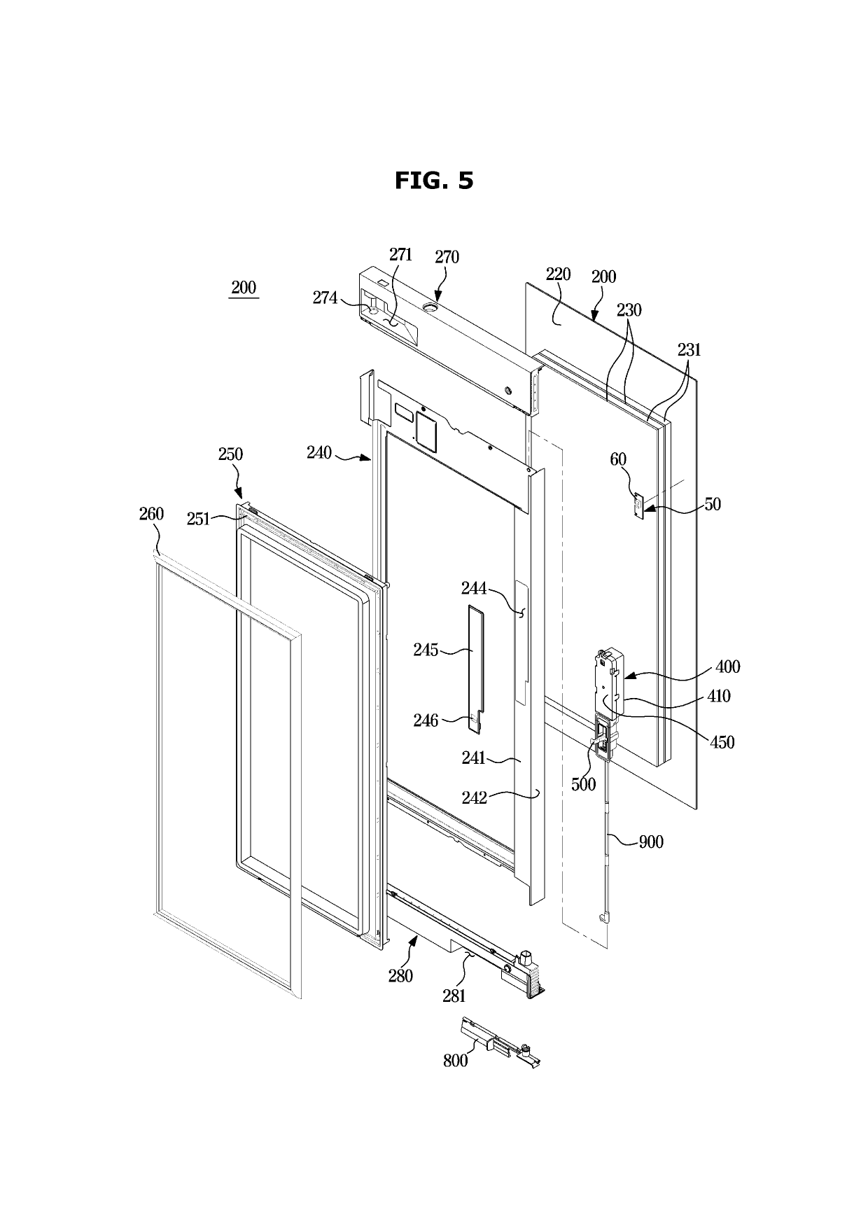

The refrigerator 1 may include an input portion 50 (e.g., an inputter) (see FIG. 5) configured to receive a release signal for unlocking the outer door 200 from a user. According to an embodiment, the input portion 50 may include a touch board 60 (see FIG. 5) including a touch sensor for detecting a user touch. A touch area 70 (see FIG. 1) may be provided on a front surface of the outer door 200, and the touch board 60 may be provided inside the outer door 200 to correspond to the touch area 70. In other words, the touch area 70 may be provided on a front surface of a front panel 220 (see FIG. 5), which will be described below, and the touch board 60 may be provided on a rear surface of the front panel 220 at a position corresponding to the touch area 70.

The touch area 70 may include an identifiable symbol or design. The touch area 70 may be formed as a printed layer provided on the front surface of the front panel 220. The touch board 60 may be configured to detect static electricity generated when a user touches the touch area 70. However, the input portion 50 is not limited to such a touch board and may be formed as a physical button, various switches, or the like.

With reference to FIG. 4, the refrigerator 1 may also include an insulation panel 230, a door chassis 240, a chassis cover 245, a door liner 250, and a gasket 260.

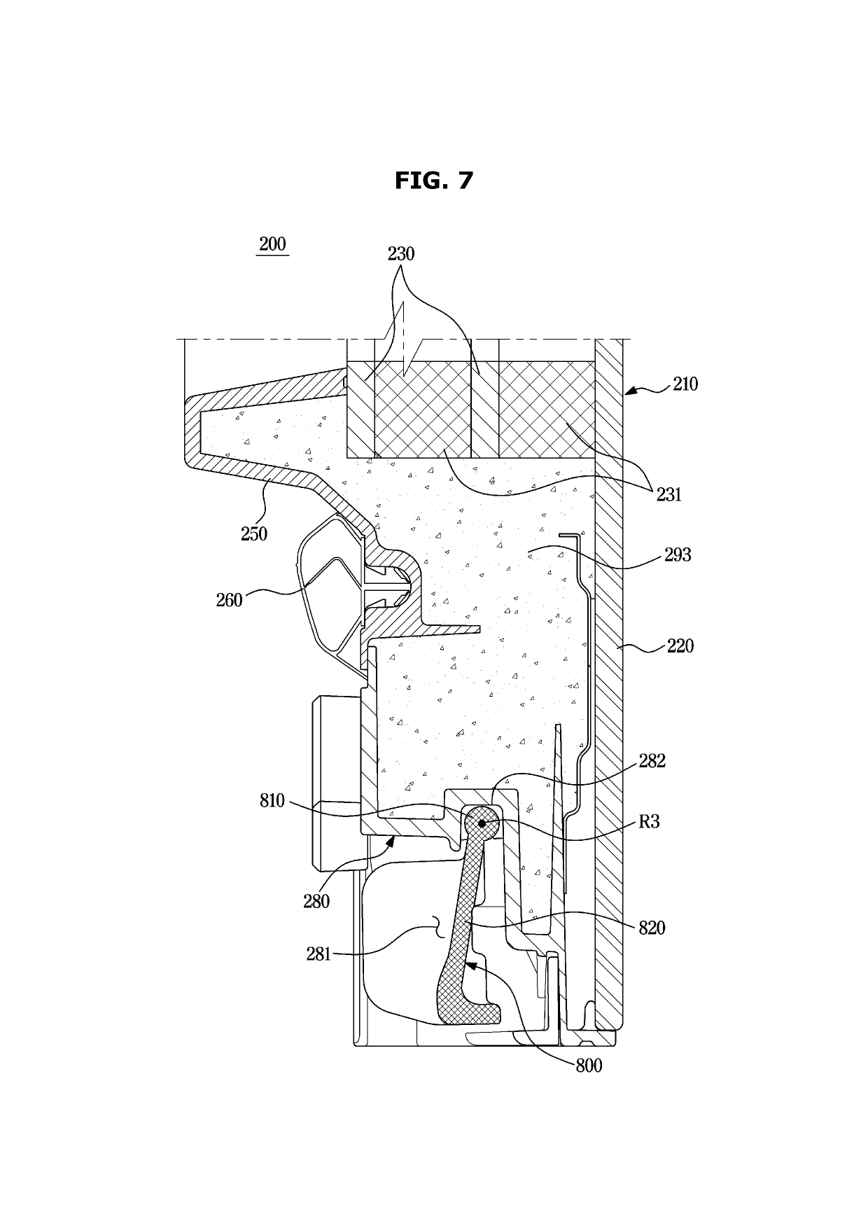

FIG. 5 is an exploded view of the outer door according to an embodiment of the disclosure. FIG. 6 is a cross-sectional view of the outer door according to an embodiment of the disclosure, taken along a line Ι-Ι of FIG. 4. FIG. 7 is a cross-sectional view of the outer door according to an embodiment of the disclosure, taken along a line II-II of FIG. 4.

The configuration of the outer door 200 and the locking device 400 will be described with reference to FIGS. 5 to 7. The outer door 200 may include a front panel assembly 210 forming a front surface of the outer door 200, the door chassis 240 forming both side surfaces of the outer door 200, the door liner 250 forming a rear rim portion of the outer door 200, an upper cap 270, and a lower cap 280.

The front panel assembly 210 may include the front panel 220 and at least one insulation panel 230 spaced apart from the front panel 220 at a rear side of the front panel 220. According to an embodiment, the front panel 220 and the insulation panel 230 may be formed of a transparent material, such as glass. Thus, the opening 110 of the inner door 100 and the door basket 121 provided in the opening 110 may be viewed through the front panel 220 and the insulation panel 230 even when the outer door 200 is in a closed state.

Depending on embodiments, the front panel 220 and the insulation panel 230 may be formed of a translucent or opaque material. Depending on embodiments, the front panel 220 and the insulation panel 230 may be formed to be switchable between a transparent state and an opaque state. Depending on embodiments, the front panel 220 may include a display.

An intermediate member 231 may be provided in a spaced-apart gap between the front panel 220 and the insulation panel 230. The intermediate member 231 may fill the spaced-apart gap between the front panel 220 and the insulation panel 230. When a plurality of insulation panels 230 are provided, the intermediate member 231 may also be provided between the insulation panels 230.

The intermediate member 231 may have a rectangular frame shape. The intermediate member 231 may support the front panel 220 and the insulation panel 230. The intermediate member 231 may allow a first insulation space 291 to be formed between the front panel 220 and the insulation panel 230 and between the plurality of insulation panels 230. In other words, the first insulation space 291 may be formed by the front panel 220, the insulation panel 230, and the intermediate member 231. The first insulation space 291 may be formed by the plurality of insulation panels 230 and the intermediate member 231. The first insulation space 291 may be form a vacuum, or an air insulation layer may be formed in the first insulation space 291.

The door chassis 240 may form both side surfaces of the outer door 200. The door chassis 240 may be formed of a metal material. The door chassis 240 may have a rectangular frame shape. As shown in FIGS. 5 and 6, the door chassis 240 may include a chassis rear portion 241, a chassis side portion 242 connected to (e.g., bent from) the chassis rear portion 241, and a chassis front portion 243 connected to (e.g., bent from) the chassis side portion 242.

The chassis rear portion 241 may form a rim portion of a rear surface of the outer door 200. The door liner 250 may be connected (e.g., coupled) to the chassis rear portion 241. The chassis side portion 242 may form a side surface of the outer door 200. The chassis front portion 243 may be connected (e.g., coupled) to the front panel 220.

A second insulation space 292 may be formed by the front panel assembly 210, the door chassis 240, the door liner 250, the upper cap 270, and the lower cap 280. The second insulation space 292 may include insulation 293 therein. The insulation 293 may include urethane foam.

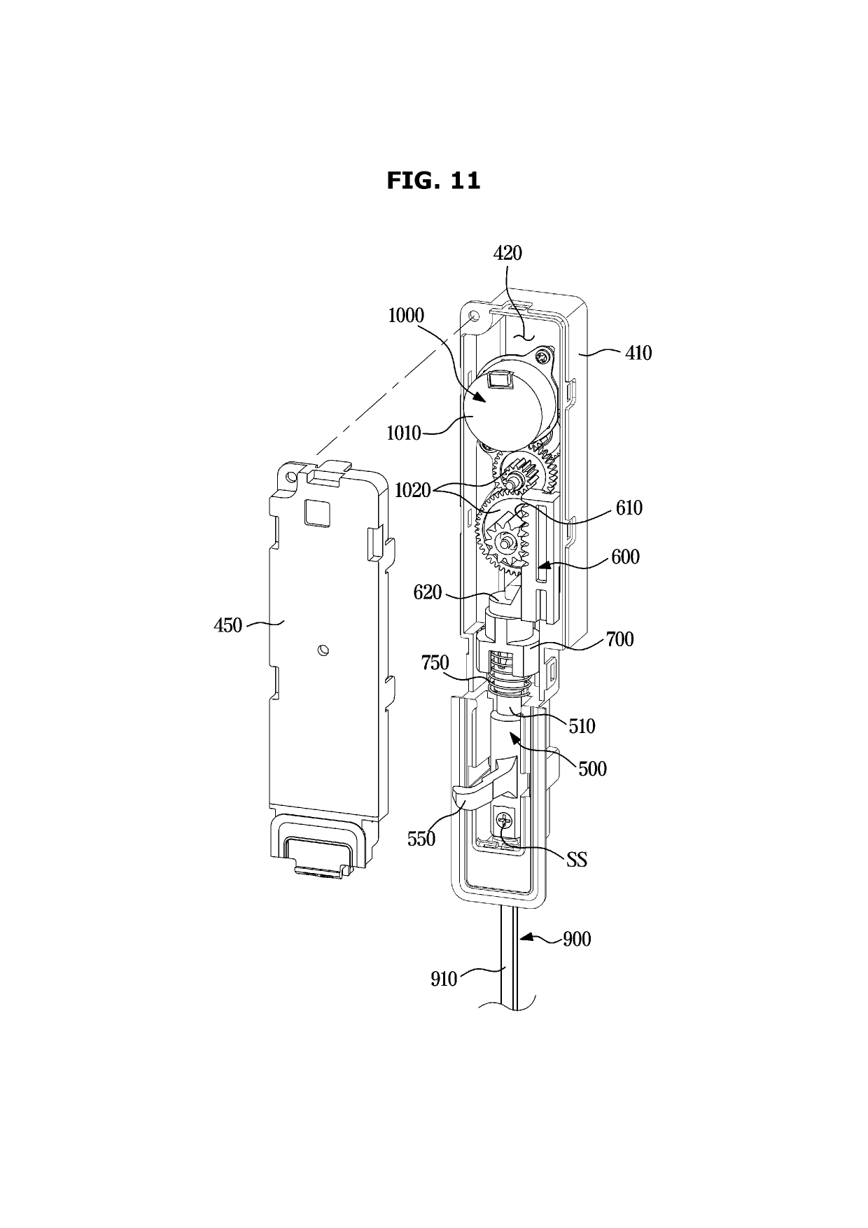

The locking device 400 may include a housing 410 in which a receiving space 420 (see FIG. 11) is formed, and a housing cover 450 detachably coupled to the housing 410 to cover the receiving space 420. The housing 410 may partition the receiving space 420 and the second insulation space 292 to prevent an insulation material from penetrating into the interior of the receiving space 420.

The receiving space 420 may accommodate a motor 1010, at least one rotating gear 1020, a pusher 600, a connector 700, the latch 500, and the like (see FIG. 11). The receiving space 420 may be formed with one side open, and the housing cover 450 may cover the open one side of the receiving space 420.

The housing 410 may be disposed on the interior of the outer door 200. The housing 410 may be disposed in a space formed between the chassis rear portion 241 and the chassis front portion 243. The housing 410 may be embedded in and secured to the insulation 293. The housing cover 450 may be disposed on the interior of the outer door 200.

The chassis rear portion 241 may include a chassis opening 244. The chassis opening 244 may be formed at a position corresponding to the housing 410 of the locking device 400. The chassis opening 244 may allow access to the interior of the housing 410.

The outer door 200 may include the chassis cover 245 detachably coupled to the chassis opening 244 to cover the chassis opening 244. The chassis cover 245 may include a chassis cover opening 246 through which the latch 500 of the locking device 400 may pass.

A connecting rod 900 connecting the latch 500 and the lever 800 may be disposed on the interior of the outer door 200. The connecting rod 900 may be rotatably received within a rod cover such that the connecting rod 900 is rotatable. The second insulation space 292 and an inner space of the rod cover may be partitioned by the rod cover.

The door liner 250 may be connected (e.g., coupled) to a rear surface of the door chassis 240. The door liner 250 may form a portion of the rear surface of the outer door 200. A gasket mounting portion 251 to which a gasket 260 is mounted may be formed to be recessed in a rear surface of the door liner 250.

The gasket 260 may be mounted to the gasket mounting portion 251 of the door liner 250. The gasket 260 may be formed of an elastic material, such as rubber. When the outer door 200 is closed, the gasket 260 may be in close contact with the front surface of the inner door 100. When the outer door 200 is closed, the gasket 260 may be tightly pressed around the opening 110 in the front surface of the inner door 100 to seal the opening 110.

The upper cap 270 may be connected (e.g., coupled) to the front panel 220 and an upper end of the door liner 250. The upper cap 270 may include a hinge receiving portion 271 formed to be recessed in one surface of the upper cap 270 to receive the upper hinge 300. The upper hinge 300 may include a hinge pin forming the outer door rotation axis R1, and the hinge receiving portion 271 may include a hinge pin insertion hole 274 into which the hinge pin is inserted.

The lower cap 280 may be connected (e.g., coupled) to the front panel 220 and a lower end of the door liner 250. The lever 800, which may be manually operated by a user to release the locking device 400, may be rotatably mounted to the lower cap 280 about the lever rotation axis R3. A lever receiving portion 281 in which the lever 800 is received may be formed in a lower portion of the lower cap 280.

The lever 800 may include a lever shaft 810 forming the lever rotation axis R3, and a lever handle portion 820 protruding from the lever shaft 810 to be operable by a user. The lever receiving portion 281 of the lower cap 280 may be provided with a shaft support portion 282 that rotatably supports the lever shaft 810.

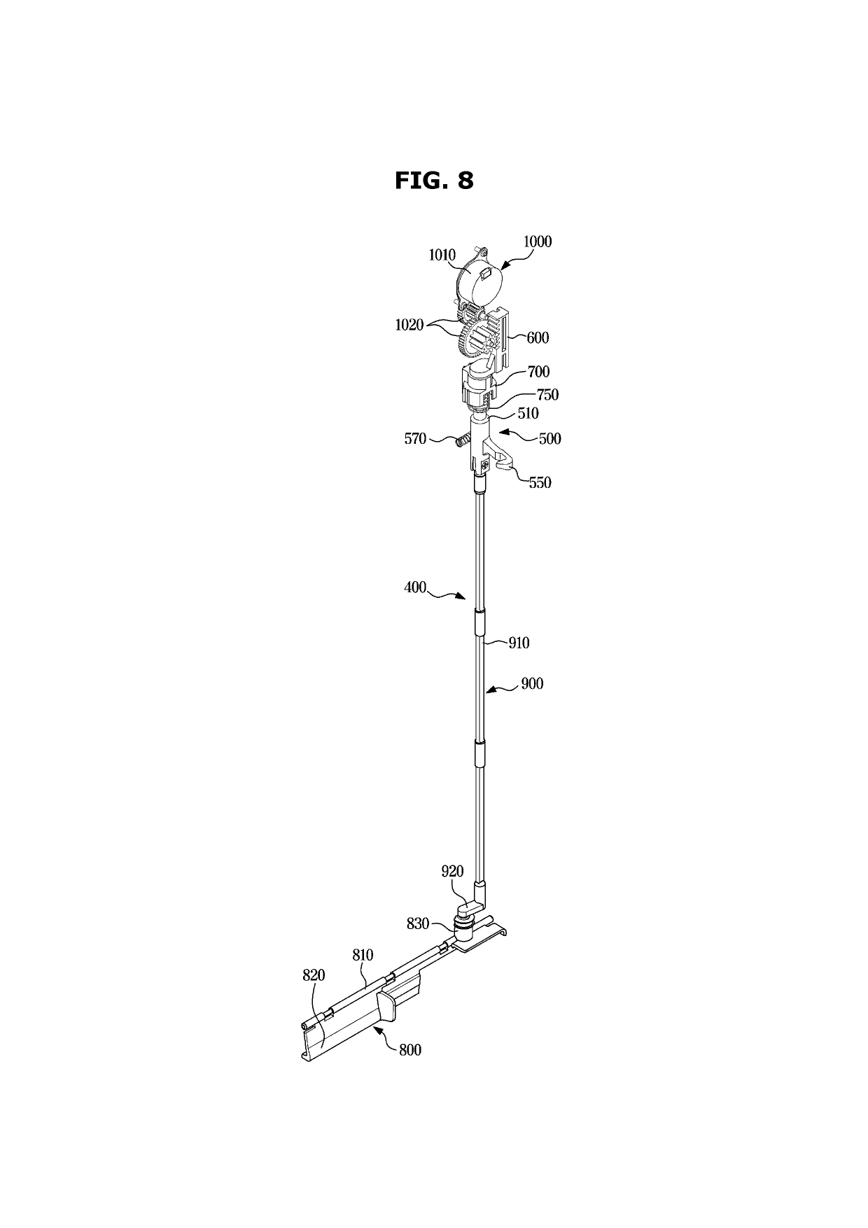

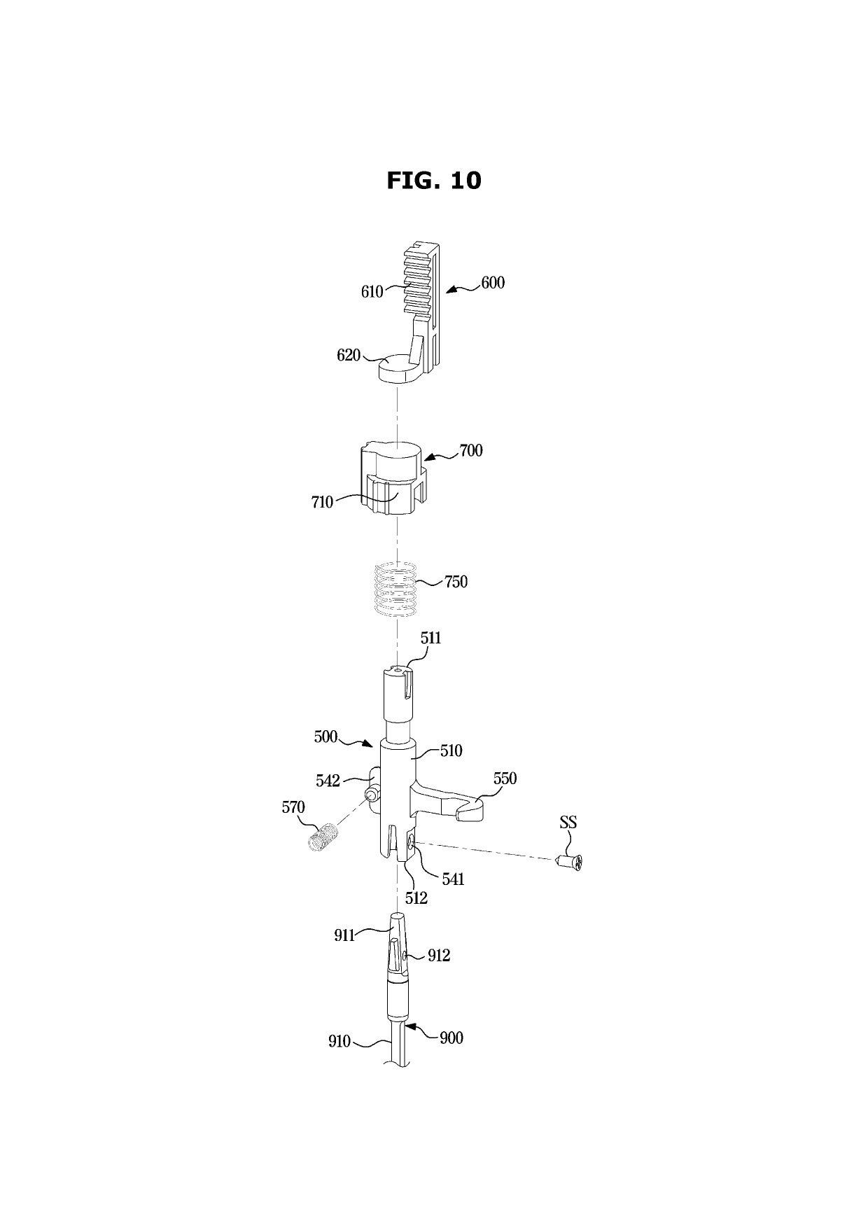

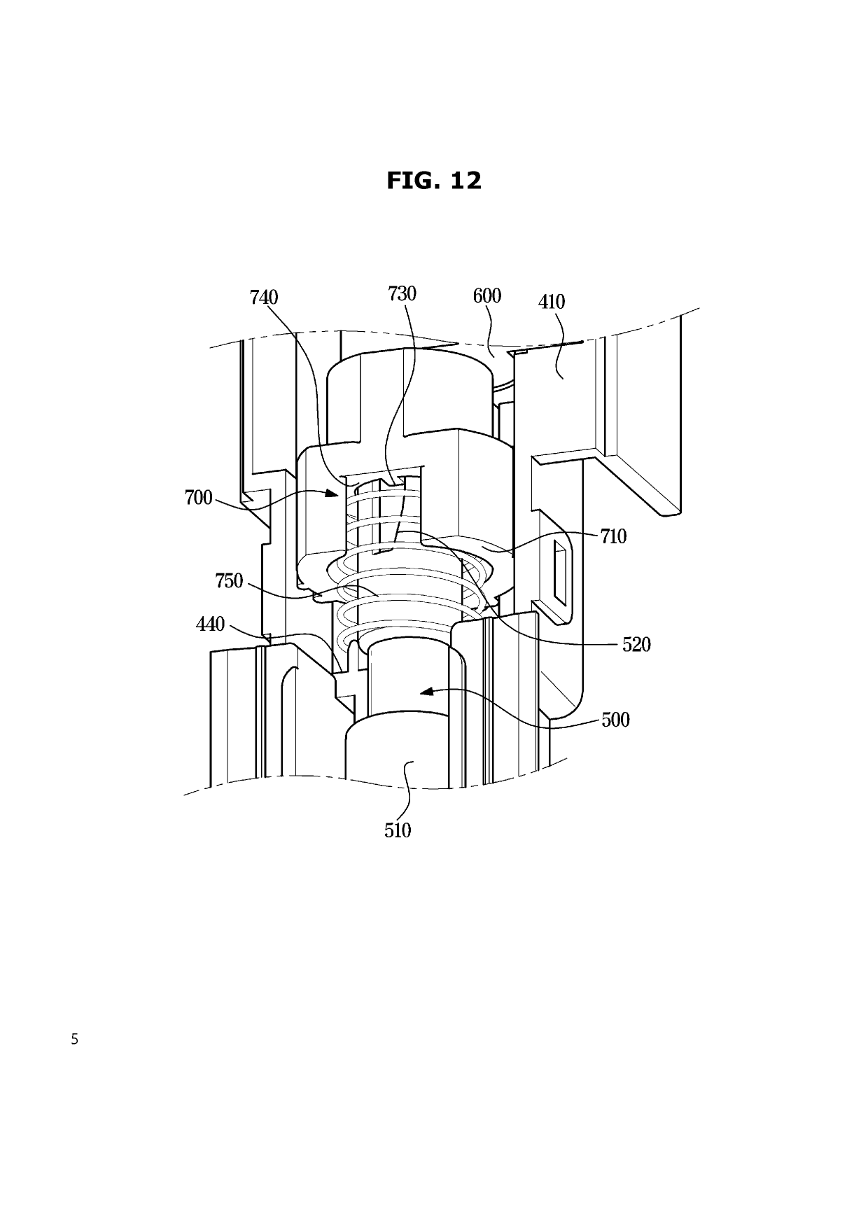

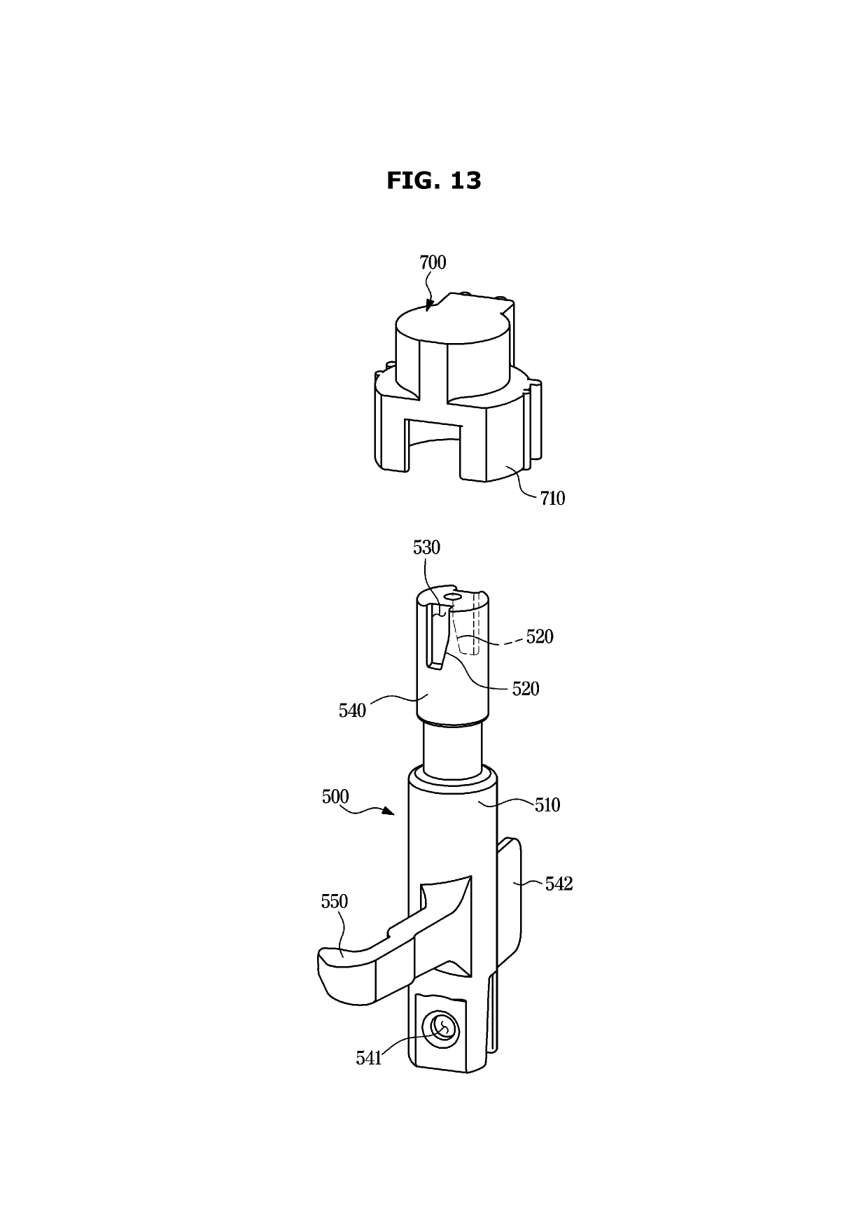

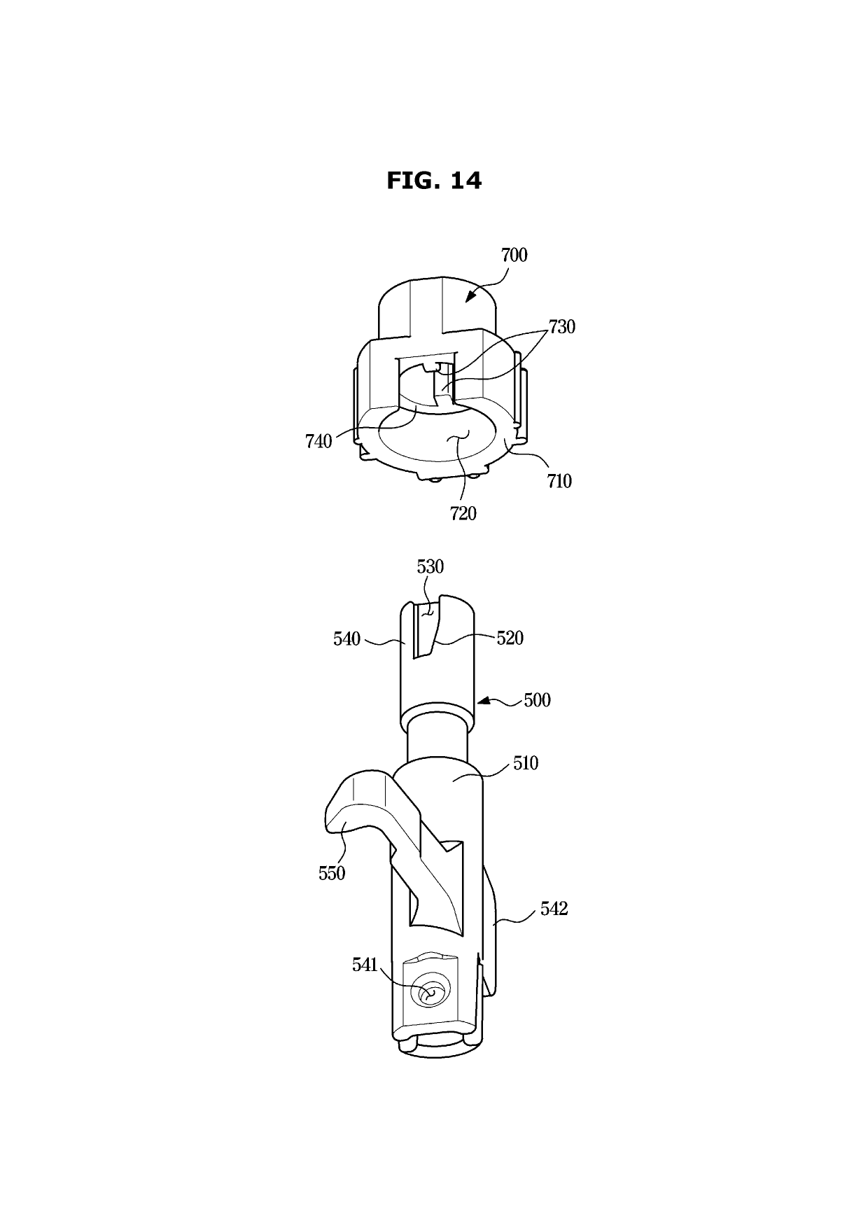

FIG. 8 is a view illustrating a locking device according to an embodiment of the disclosure. FIG. 9 is a view illustrating a coupling structure of a lever and a connecting rod according to an embodiment of the disclosure. FIG. 10 is an exploded view of a part of a locking device according to an embodiment of the disclosure. FIG. 11 is a view illustrating a housing cover separated from a housing of the locking device according to an embodiment of the disclosure. FIG. 12 is a view illustrating a coupling structure of a connector and a latch according to an embodiment of the disclosure. FIG. 13 is a perspective view illustrating the connector and the latch according to an embodiment of the disclosure. FIG. 14 is another perspective view illustrating the connector and the latch according to an embodiment of the disclosure.

The configuration of a locking device according to an embodiment of the disclosure will be described with reference to FIGS. 8 to 14.

The locking device 400 may include the latch 500 configured to be rotatable about the latch rotation axis R2, a locking means for locking the outer door 200, the manual unlocking portion configured to manually rotate the latch 500 to unlock the outer door 200, and the automatic unlocking portion configured to automatically rotate the latch 500 to unlock the outer door 200.

The latch 500 may include a latch body portion 510 forming the latch rotation axis R2, and a latch hook portion 550 protruding from the latch body portion 510 so as to be coupled to the fixing portion 140 formed on the inner door 100. The latch body portion 510 may have a cylindrical shape, and the latch hook portion 550 may protrude radially outward from an outer circumferential surface of the latch body portion 510. The latch hook portion 550 may be formed to be bent in a hook shape.

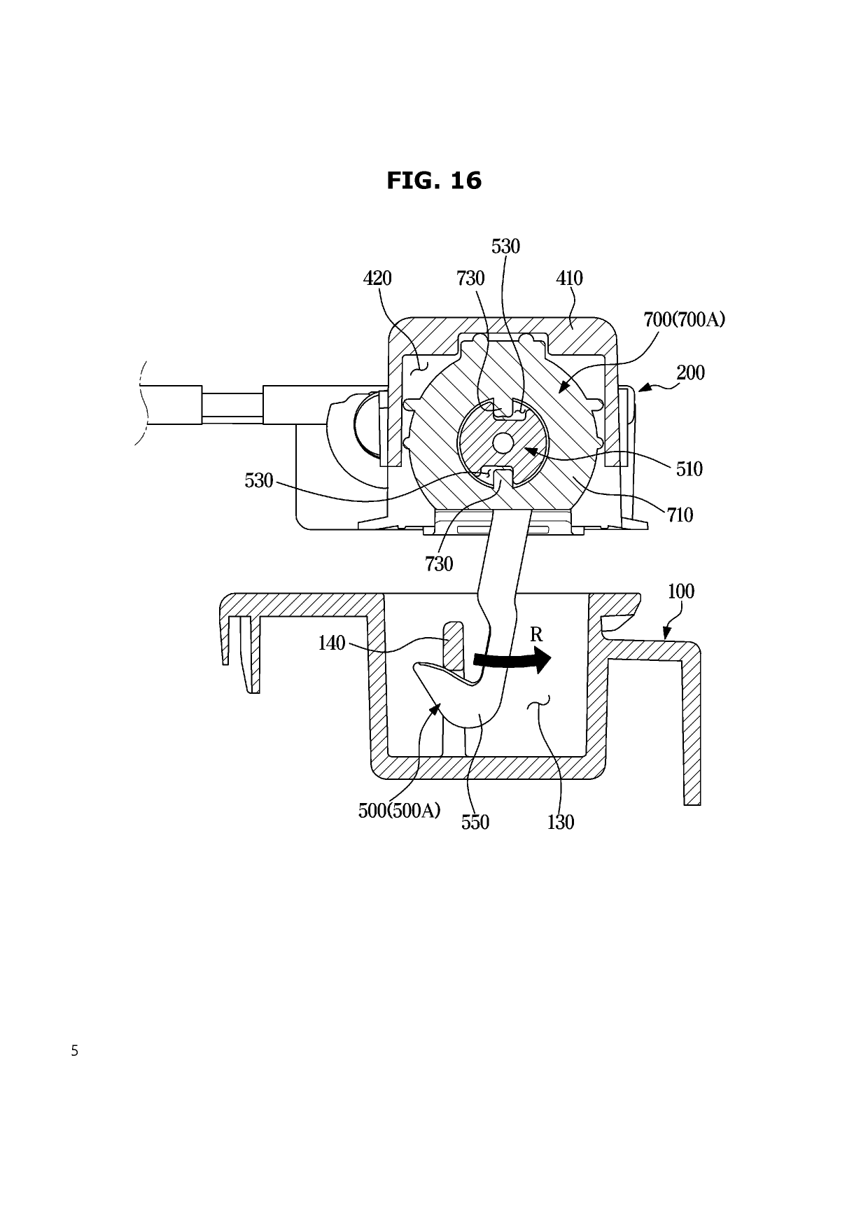

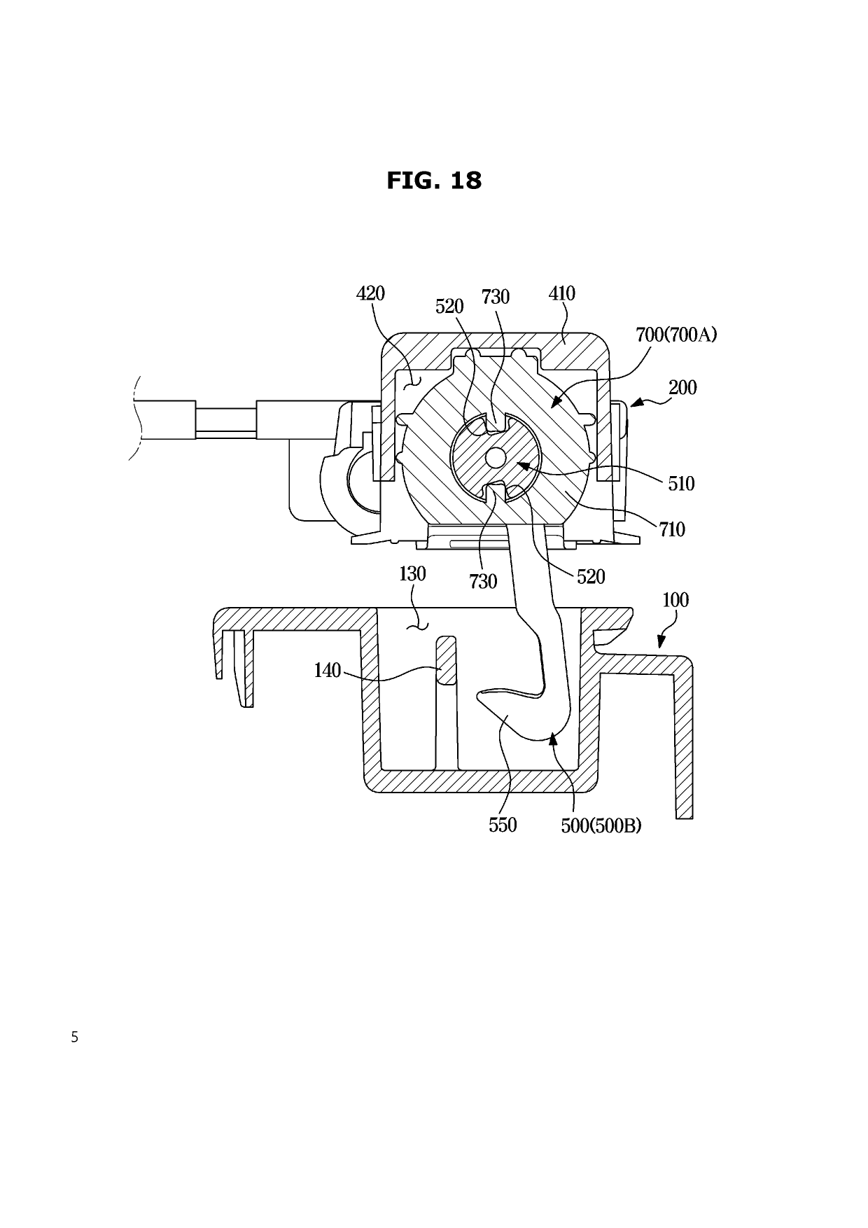

The latch 500 may rotate between an engaged position 500A (see FIG. 16) where the latch hook portion 550 is engaged with the fixing portion 140, and a disengaged position 500B (see FIG. 18) where the latch hook portion 550 is released from the fixing portion 140.

The locking means for locking the outer door 200 may include a latch elastic member 570. The latch elastic member 570 may include a compression spring. The latch elastic member 570 may elastically bias the latch 500 toward the engaged position. Thus, when no external force is applied to the latch 500, the latch 500 may rotate to the engaged position by the elastic force of the latch elastic member 570, and the latch hook portion 550 and the fixing portion 140 may be engaged, thereby causing the outer door 200 to be in a locked state.

One end of the latch elastic member 570 may be supported on the housing 410 of the locking device 400, and the opposite end of the latch elastic member 570 may be supported on the latch 500 (see FIG. 6). The latch 500 may include a door elastic member support portion 542 (see FIG. 10) to support the latch elastic member 570.

The manual unlocking portion may include the lever 800 configured to be manually operated by a user. The lever 800 may be configured to be rotatable about the lever rotation axis R3 at the lower portion of the outer door 200.

The latch 500 may be rotated by an operating force applied to the lever 800. The operating force applied to the lever 800 may be transmitted to the latch 500 via one end of the latch 500, thereby causing the latch 500 to rotate. In an example, the operating force applied to the lever 800 may be transmitted to the latch 500 through a lower end portion 512 (see FIG. 10) of the latch 500.

The manual unlocking portion may include the connecting rod 900 provided between the lever 800 and the latch 500 to transmit the operating force applied to the lever 800 to the latch 500. The connecting rod 900 may be configured to be rotatable about a rod rotation axis R4. The rod rotation axis R4 may be formed on the same line as the latch rotation axis R2. The connecting rod 900 may be connected (e.g., coupled) to one end of the latch 500. In an example, the connecting rod 900 may be connected (e.g., coupled) to the lower end portion 512 of the latch 500. The connecting rod 900 may be connected (e.g., coupled) to the latch 500 such that the connecting rod 900 rotates together with the latch 500.

The connecting rod 900 may include a rod body portion 910 forming the rod rotation axis R4, and a rod extension portion 920 extending radially from the rod body portion 910.

The rod body portion 910 may include a coupling end portion 911 coupled to the latch 500. The coupling end portion 911 may be inserted into and coupled to a portion of the latch 500. The coupling end portion 911 and the latch 500 may be connected (e.g., coupled) through a fastening member SS. To this end, a coupling hole 912 may be formed in the coupling end portion 911, and a coupling hole 541 may be formed in the latch 500.

The connecting rod 900 may include a connecting pin 930 provided on the rod extension portion 920 for the lever 800 to be coupled. The connecting pin 930 may be formed at a position eccentrically from the rod rotation axis R4.

The lever 800 may include the lever shaft 810 forming the lever rotation axis R3, the lever handle portion 820 protruding from the lever shaft 810 to be operable by a user, and a pin coupling portion 830 configured to be coupled to the connecting pin 930.

With such a configuration, when a user applies a physical operating force to the lever 800 via the lever handle portion 820, the lever 800 may rotate about the lever rotation axis R3, and the operating force may be transmitted to the connecting rod 900 via the pin coupling portion 830 and the connecting pin 930. In other words, a rotational motion of the lever 800 about the lever rotation axis R3 may be converted into a rotational motion of the connecting rod 900 about the rod rotation axis R4.

The connecting rod 900 may be connected (e.g., coupled) to the latch 500 so as to rotate together with the latch 500, so that the latch 500 may be rotated in response to rotation of the connecting rod 900.

With such a configuration, the latch 500 may be rotated from the engaged position to the disengaged position by the user’s operating force, thereby disengaging the latch 500 and the fixing portion 140 to unlock the outer door 200.

When the user’s operating force applied to the lever 800 is removed, the latch 500 may be rotated to the engaged position by the elastic force of the latch elastic member 570. When the latch 500 is rotated to the engaged position, the rotational motion of the latch 500 may be conversely converted into the rotational motion of the lever 800 via the connecting pin 930 and the pin coupling portion 830.

The automatic unlocking portion may include a drive source 1000 that generates a driving force based on a release signal input to the input portion 50. The refrigerator 1 may include a controller that controls operation of the drive source 1000 based on a signal input to the input portion 50. The input portion 50 may receive input from a user and communicate the input to the controller, and the controller may process the communicated input to operate the drive source 1000. The refrigerator may include a communication portion (e.g., a communication circuitry) for communication with an external device. The controller may also control the operation of the drive source 1000 by receiving a user release signal from the external device via the communication portion.

The latch 500 may be rotated by the driving force generated by the drive source 1000. The driving force generated by the drive source 1000 may be transmitted to the latch 500 through an opposite end of the latch 500. In an example, the driving force may be transmitted to the latch 500 through an upper end portion 511 (see FIG. 10) of the latch 500.

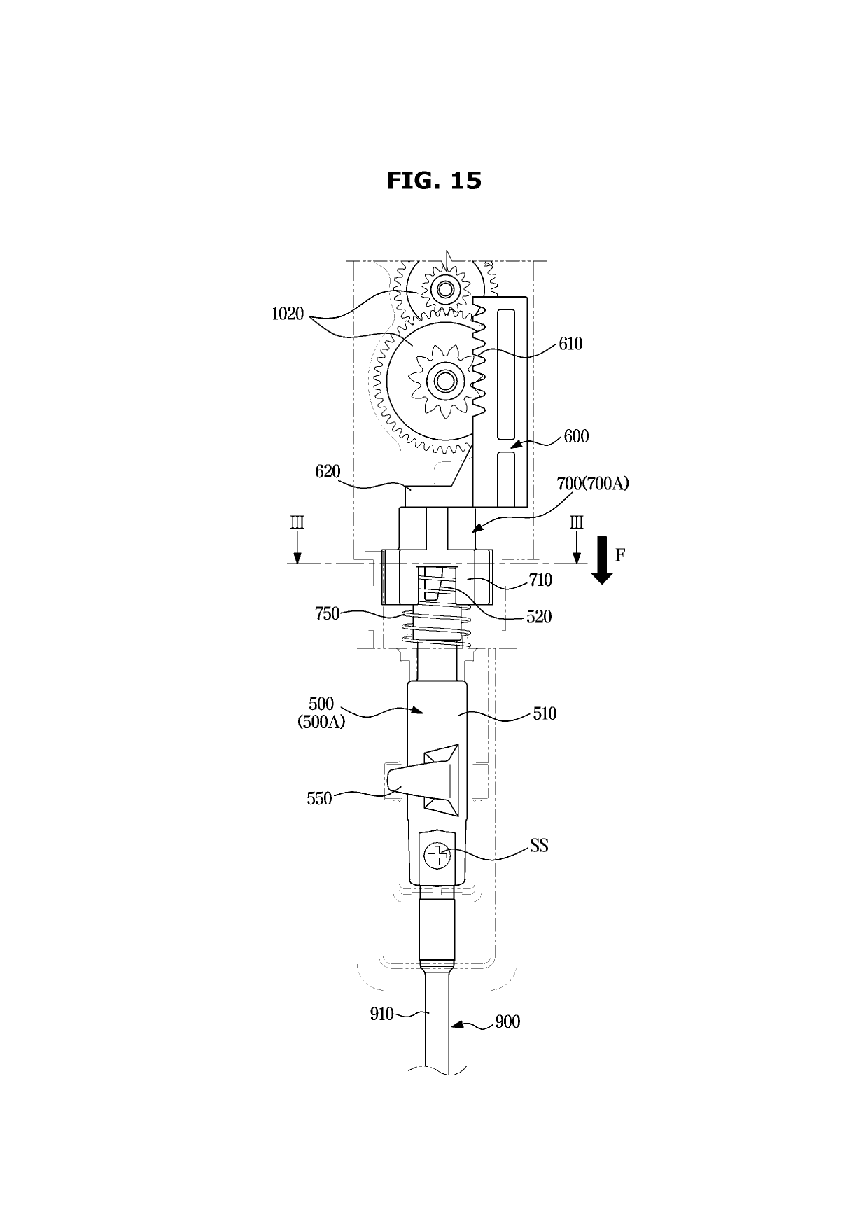

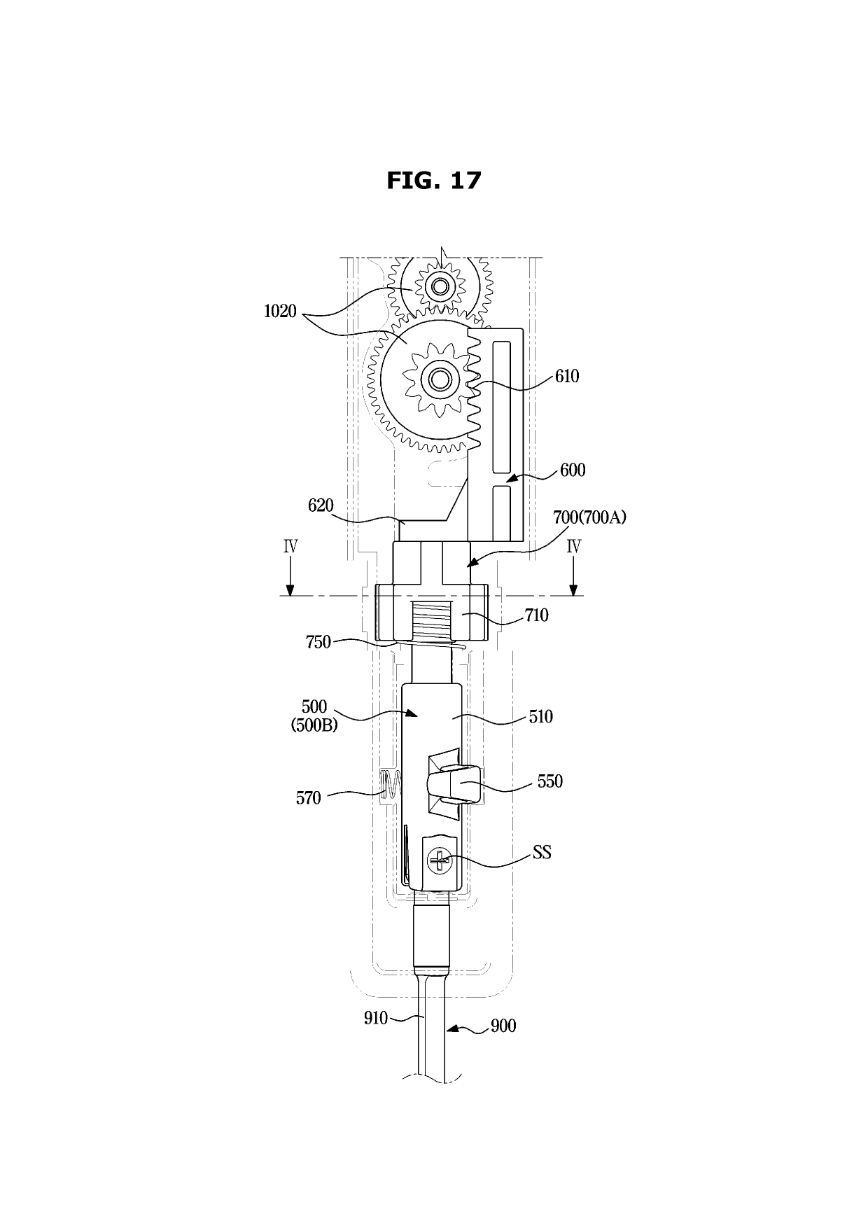

The automatic unlocking portion may include the pusher 600 that is moved linearly along the latch rotation axis R2 through the driving force, and the connector 700 that is moved linearly between a default position 700A (see FIG. 15) and an advanced position 700B (see FIG. 17) in response to the linear movement of the pusher 600. As the connector 700 moves from the default position to the advanced position, the connector 700 may press against the latch 500. The latch 500 may be rotated from the engaged position to the disengaged position by the pressing of the connector 700.

According to an embodiment, the pusher 600 and the connector 700 may be formed separately. In this case, the automatic unlocking portion may include a connector elastic member 750 configured to elastically bias the connector 700 to the default position. The connector elastic member 750 may include a compression spring. One end of the connector elastic member 750 may be supported on the connector 700, and the opposite end of the connector elastic member 750 may be supported on the housing 410. The connector 700 may be provided with a connector elastic member support portion 740 (see FIG. 12) configured to support the connector elastic member 750, and the housing 410 may be provided with a connector elastic member support portion 440 (see FIG. 12) configured to support the connector elastic member 750.

The drive source 1000 may be the motor 1010 that generates a rotational force. The motor 1010 may be a motor capable of forward and reverse drive. The automatic unlocking portion may include at least one rotating gear 1020 for transmitting the rotational force generated by the motor 1010 to the pusher 600. The at least one rotating gear 1020 may be connected to a motor shaft of the motor 1010 to rotate. The at least one rotating gear 1020 may have the form of a two-stage spur gear to transmit the rotational force at a reduced speed. In an example, the at least one rotating gear 1020 may include an upper spur gear and a lower spur gear having a smaller radius than a radius of the upper spur gear.

The pusher 600 may include a rack gear 610 that meshes with the at least one rotating gear 1020 to move linearly along the latch rotation axis R2. With such a configuration, the rotational force of the motor 1010 may be converted into the linear motion of the pusher 600. In an example, when the motor 1010 is driven in the forward direction, the pusher 600 may move linearly in a direction approaching the latch 500, and when the motor 1010 is driven in the reverse direction, the pusher 600 may move in the opposite direction.

The pusher 600 may include a pressing portion 620 that presses the connector 700. When the pusher 600 is moved in a direction approaching the latch 500, the pusher 600 may press the connector 700, causing the connector 700 to move linearly from the default position to the advanced position. At this time, the connector elastic member 750 may be compressed to accumulate an elastic force.

Conversely, when the pusher 600 is moved in a direction away from the latch 500, the connector 700 may return from the advanced position to the default position by the elastic force of the connector elastic member 750.

According to an embodiment, the pusher 600 and the connector 700 may be integrally formed. In this case, since the pusher 600 and the connector 700 can advance and retreat together, the connector elastic member 750 may be omitted.

As the connector 700 moves from the default position to the advanced position, the connector 700 may press the latch 500, causing the latch 500 to rotate from the engaged position to the disengaged position. To this end, the latch 500 may include an inclined surface 520, and the connector 700 may include a connector protrusion 730 that presses against the inclined surface 520.

The inclined surface 520 may be formed in an outer circumferential surface 540 of the latch body portion 510. At least one or more inclined surfaces 520 may be formed on the outer circumferential surface 540 of the latch body portion 510. The inclined surface 520 may be formed to be inclined with respect to a pressing direction of the connector protrusion 730. In other words, the inclined surface 520 may be formed to be inclined with respect to a linear movement direction of the connector 700 or the latch rotation axis R2.

The connector 700 may include a rotation guide 710 formed to surround the latch body portion 510 to guide the rotation of the latch 500. A portion of the latch body portion 510 may be received in a guide inner space 720 formed inside the rotation guide 710. The connector protrusion 730 may be formed to protrude from an inner surface of the rotation guide 710. At least one or more connector protrusions 730 may be formed on the inner surface of the rotation guide 710.

With such a configuration, when a user inputs a release signal to the input portion 50, the motor 1010 may rotate in the forward direction, causing the drive source 1000 to generate a driving force, and the generated driving force may cause the pusher 600 and the connector 700 to move linearly in a direction toward the latch 500. In other words, the connector 700 may move from the default position to the advanced position, thereby causing the connector protrusion 730 to press against the inclined surface 520, so that the latch 500 may rotate from the engaged position to the disengaged position. As the latch 500 rotates from the engaged position to the disengaged position, the engagement of the latch 500 and the fixing portion 140 may be released, thereby unlocking the outer door 200.

At this time, when the motor 1010 of the drive source 1000 rotates in the reverse direction, the pusher 600 and the connector 700 may move linearly in a direction away from the latch 500. In other words, the connector 700 may move from the advanced position to the default position, and accordingly, the pressing of the connector protrusion 730 against the inclined surface 520 may be released. As the pressing of the connector protrusion 730 against the inclined surface 520 is lost, the latch 500 may be rotated to the engaged position by the elastic force of the latch elastic member 570.

According to an embodiment of the disclosure, the latch 500 may be configured to be rotatable from the engaged position to the disengaged position without interfering with the connector 700 when the connector 700 is in the default position. In an example, when a user rotates the latch 500 from the engaged position to the disengaged position via the manual unlocking portion, the latch 500 may rotate from the engaged position to the disengaged position without interfering with the connector 700.

To this end, the latch 500 may include an avoidance portion 530 (see FIGS. 13, 14, and 16) formed to be recessed in the outer circumferential surface 540 of the latch body portion 510 so as not to interfere with the connector protrusion 730. According to some embodiments, the avoidance portion 530 may be referred to as an avoidance opening.

Specifically, during rotation of the latch 500 from the engaged position to the disengaged position by the operating force applied to the lever 800 by the user with the connector 700 in the default position, the avoidance portion 530 may be formed to be recessed in the outer circumferential surface 540 of the latch 500 to prevent the latch 500 from interfering with the connector protrusion 730.

In other words, the avoidance portion 530 may be formed such that, in a state in which the connector 700 is in the default position 700A and the latch 500 is in the engaged position 500A, the avoidance portion 530 is positioned in a predetermined rotational direction from the connector protrusion 730. Here, the predetermined rotational direction may be opposite to the direction R in which the latch 500 rotates from the engaged position to the disengaged position (see FIG. 16).

With such a configuration, when a user unlocks the outer door 200 via the manual unlocking portion, the latch 500 does not interfere with the connector 700 and thus no load is applied to the automatic unlocking portion. Thus, the durability of the motor 1010, the rotating gear 1020, and the like may be improved, and failure may be prevented from occurring.

FIG. 15 is a view illustrating a state in which the connector is in a default position and the latch is in an engaged position, according to an embodiment of the disclosure. FIG. 16 is a cross-sectional view taken along a line III-III of FIG. 15. FIG. 17 is a view illustrating a state in which the connector is in an advanced position and the latch is in a disengaged position, according to an embodiment of the disclosure. FIG. 18 is a cross-sectional view taken along a line IV-IV of FIG. 15.

The operation of the automatic unlocking portion of the locking device according to an embodiment of the disclosure will be described with reference to FIGS. 15 to 18.

As shown in FIGS. 15 and 16, the connector 700 may be positioned in the default position 700A by the elastic force of the connector elastic member 750 because the pusher 600 does not press the connector 700 when the drive source is not actuated. Also, because the connector 700 is positioned in the default position 700A, the connector protrusion 730 of the connector 700 does not press the inclined surface 520 of the latch 500, so the latch 500 may be positioned in the engaged position 500A by the elastic force of the latch elastic member 570. Thus, the latch 500 and the fixing portion 140 may be engaged and the outer door 200 may be in a locked state.

Based on the user’s release signal being input to the input portion 50, the motor 1010, which is the drive source 1000, may rotate in the forward direction, and the rotational force of the motor 1010 may be converted into the linear motion of the pusher 600 via the rotating gear 1020.

As the pusher 600 moves linearly to press the connector 700, the connector 700 may be moved in a direction F toward the latch 500. In other words, the driving force of the drive source 1000 may move the connector 700 from the default position 700A to the advanced position 700B. As the connector 700 moves from the default position 700A to the advanced position 700B, the connector protrusion 730 of the connector 700 may press against the inclined surface 520 of the latch 500, thereby causing the latch 500 to rotate from the engaged position 500A to the disengaged position 500B. Accordingly, the latch 500 and the fixing portion 140 may be disengaged and the outer door 200 may be in an openable state.

When the outer door 200 is unlocked and in the openable state, the outer door 200 may be automatically opened by the elastic force of the door elastic member 390 (see FIG. 4).

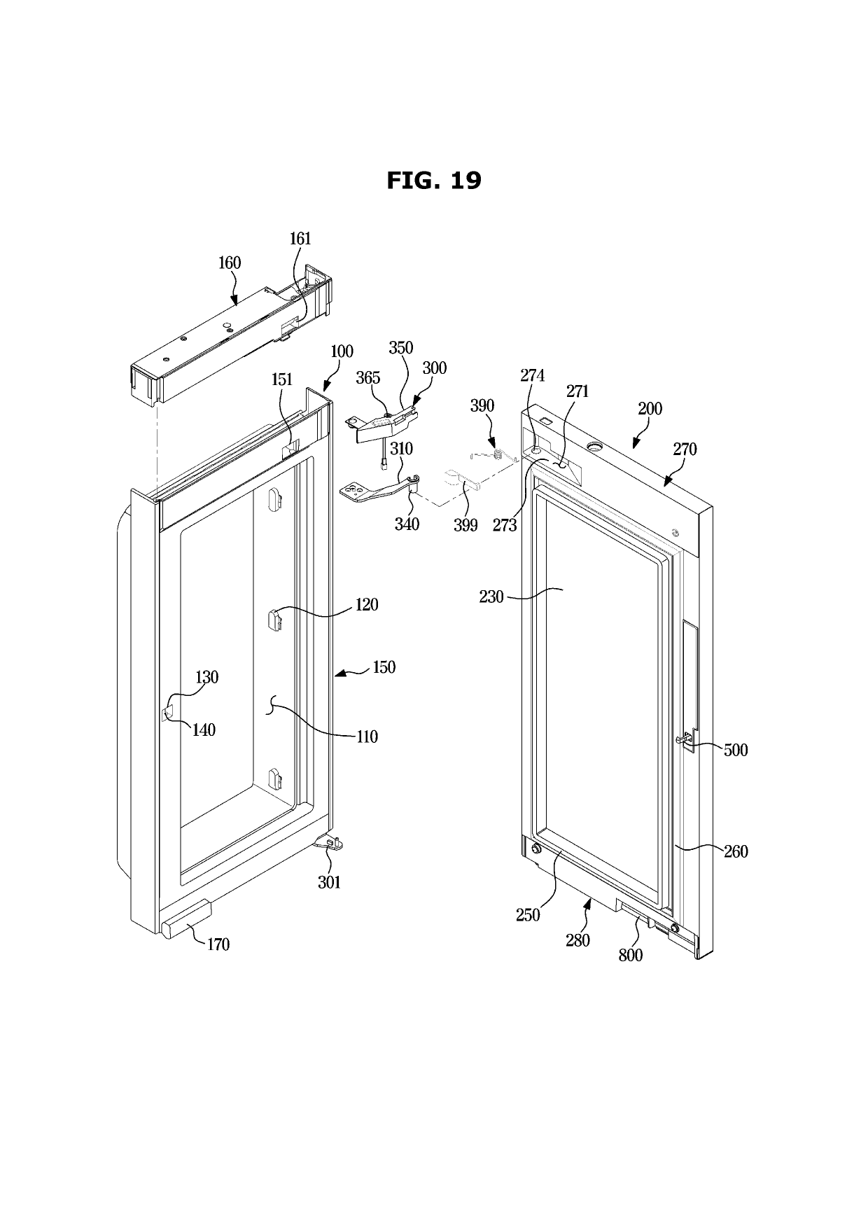

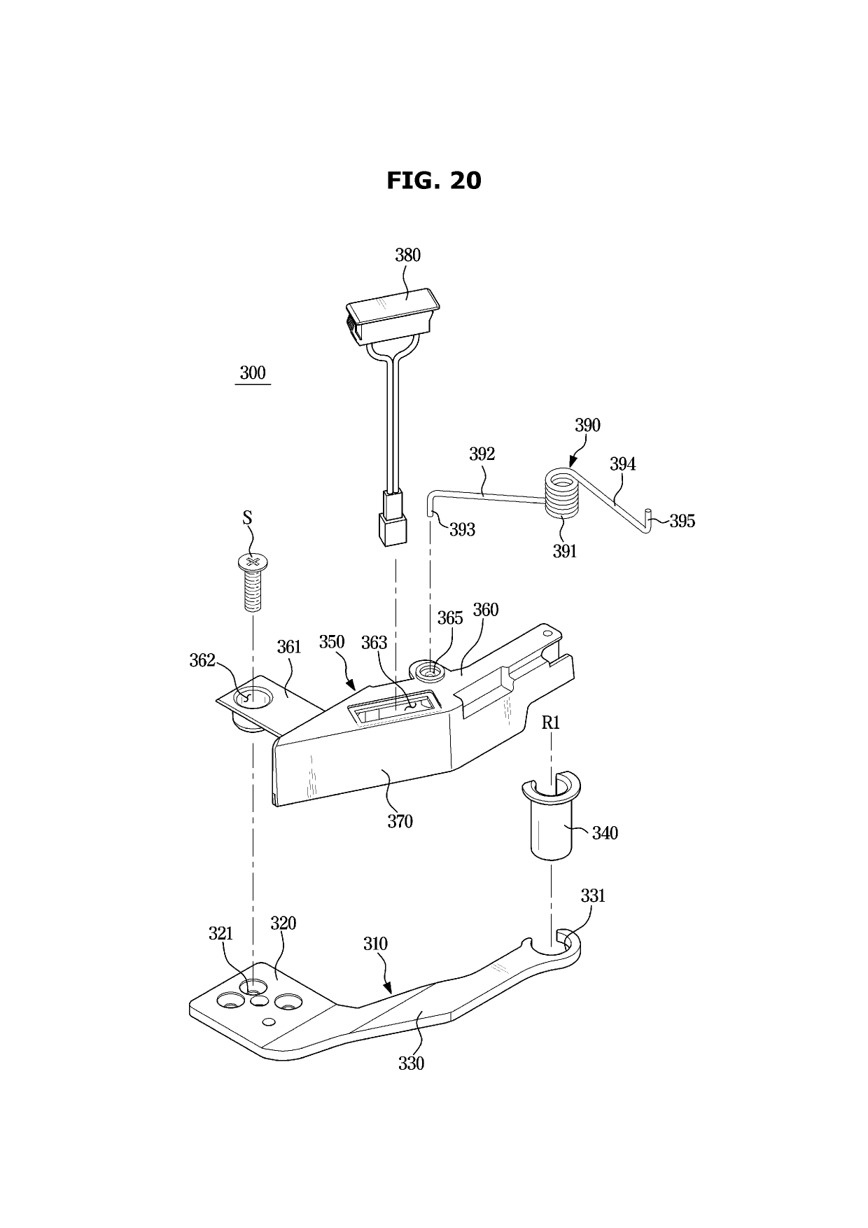

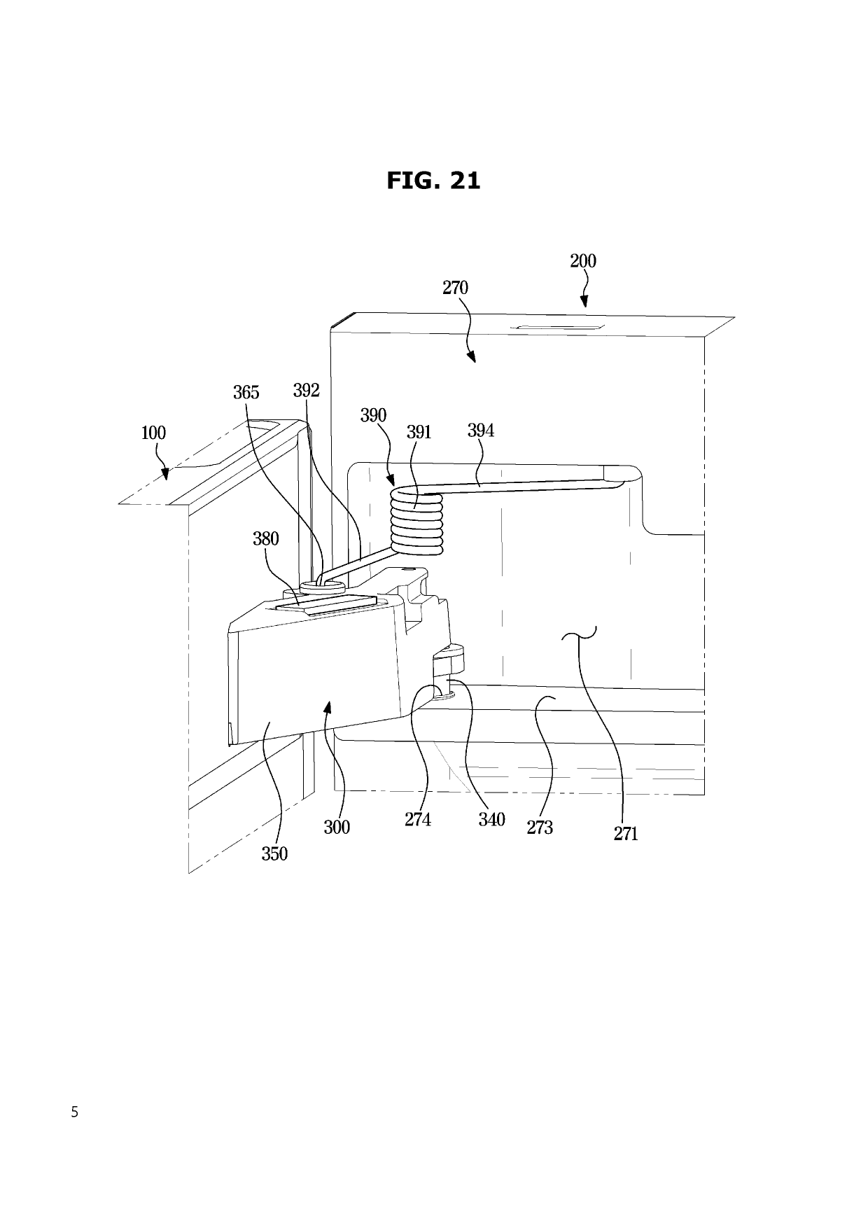

FIG. 19 is a view illustrating a coupling structure of an inner door, an outer door, and a hinge, according to an embodiment of the disclosure. FIG. 20 is an exploded view of the hinge according to an embodiment of the disclosure. FIG. 21 is a view illustrating a coupling structure of a door elastic member according to an embodiment of the disclosure.

Referring to FIGS. 19 to 21, the upper hinge 300 may connect the outer door 200 and the inner door 100, and may rotatably support the outer door 200.

The upper hinge 300 may include a hinge bracket 310. The hinge bracket 310 may be formed of a metal material having rigidity. The hinge bracket 310 may include a door coupling portion 320 connected (e.g., coupled) to the inner door 100, and a hinge arm 330 extending from the door coupling portion 320 toward the outer door 200.

The door coupling portion 320 may be connected (e.g., coupled) to the inner door 100 via a fastening member S. To this end, a coupling hole 321, to which the fastening member S is coupled, may be formed in the door coupling portion 320. The door coupling portion 320 may be connected (e.g., coupled) to the upper cap 160 through a through-hole 151 formed in the front surface of the inner door 100 and a through-hole 161 formed in the upper cap 160 of the inner door 100.

One end of the hinge arm 330 may be provided with a hinge pin 340 forming the outer door rotation axis. The hinge pin 340 may be connected (e.g., coupled) to a hinge pin coupling portion 331 formed at one end of the hinge arm 330. However, unlike the present embodiment, the hinge pin 340 may be integrally formed with the hinge arm 330.

The hinge pin 340 may be inserted into the hinge pin insertion hole 274 formed in the upper cap 270 of the outer door 200. The hinge pin insertion hole 274 may be provided in the hinge receiving portion 271 formed to receive the upper hinge 300 in the upper cap 270 of the outer door 200. The hinge pin insertion hole 274 may be formed on an inner surface of the hinge receiving portion 271. The hinge pin insertion hole 274 may be formed on a lower inner surface 273 of the hinge receiving portion 271.

The upper hinge 300 may include a hinge cover 350 coupled to the hinge bracket 310 to cover the hinge bracket 310. The hinge cover 350 may be formed of a resin material. The hinge cover 350 may cover the hinge bracket 310 such that the hinge bracket 310 is not exposed to an outside. The hinge cover 350 may be connected (e.g., coupled) to the hinge bracket 310 through the fastening member S. The fastening member S may be connected (e.g., coupled) to the upper cap 160 by passing through a coupling hole 362 formed in the hinge cover 350 and the coupling hole 321 formed in the hinge bracket 310.

The hinge cover 350 may include a hinge cover upper surface 360 and a hinge cover side surface 370. The hinge cover upper surface 360 may be provided with a reed switch 380 for detecting opening/closing of the outer door 200. A switch mounting portion 363 for mounting the reed switch 380 may be formed on the hinge cover upper surface 360.

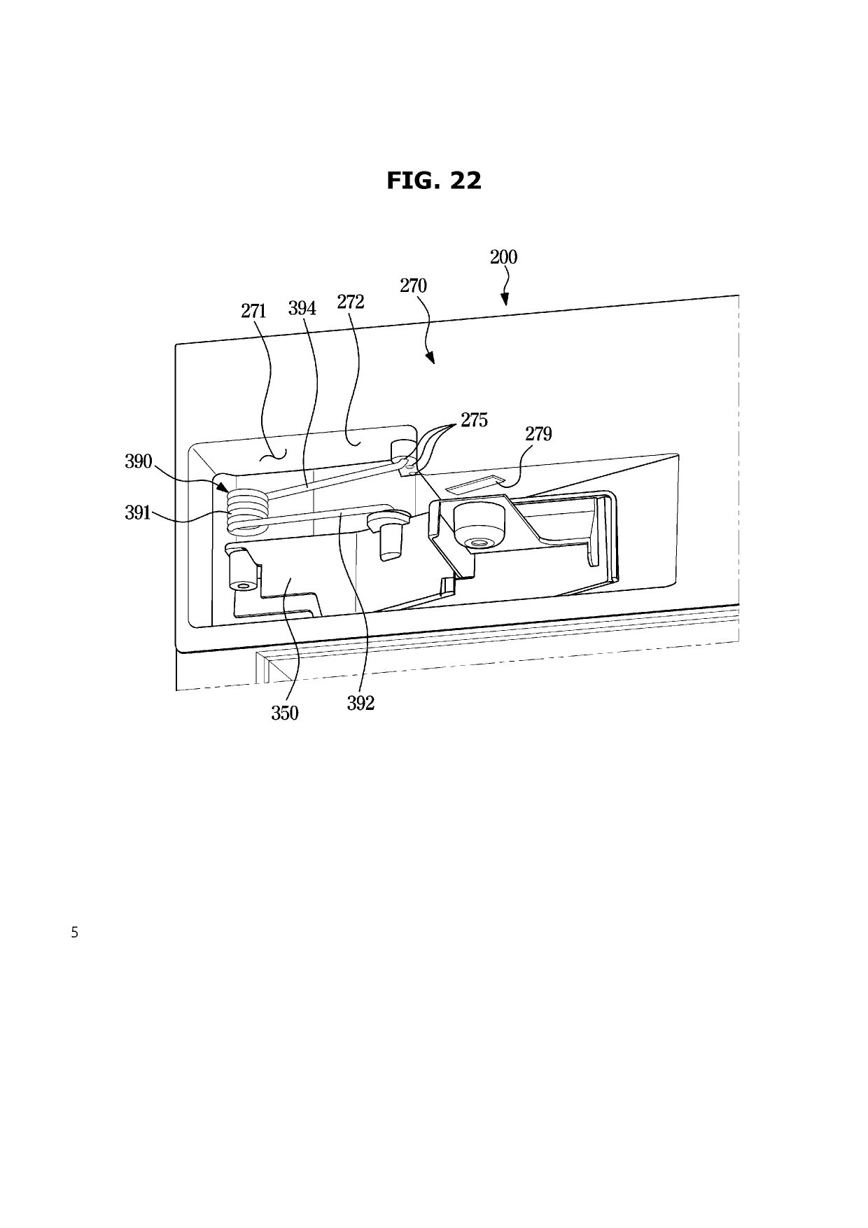

The reed switch 380 may detect the opening/closing of the outer door 200 by interacting with a magnet 279 (see FIG. 22) provided on the outer door 200. The magnet 279 may be positioned on an upper portion of the hinge receiving portion 271 of the outer door 200.

The reed switch 380 may include two reeds and may be formed such that when the magnet 279 approaches within a predetermined distance, the two reeds are attracted each other to close the contact, and when the magnet 279 moves away from the predetermined distance, the two reeds are elastically separated to open the contact. Alternatively, or conversely, it may be formed such that the contact is opened when the magnet 279 approaches the reed switch 380, and is closed when the magnet 279 moves away from the reed switch 380.

One end of the door elastic member 390 may be connected (e.g., coupled) to the hinge cover upper surface 360. A first support hole 365, into which one end of the door elastic member 390 is inserted and coupled, may be formed in the hinge cover upper surface 360.

The door elastic member 390 may be configured to elastically bias the outer door 200 in the opening direction. One end of the door elastic member 390 may be connected (e.g., coupled) to and supported by the upper hinge 300, and the opposite end of the door elastic member 390 may be connected (e.g., coupled) to and supported by the outer door 200.

The door elastic member 390 may be a torsion spring having a coiled portion 391 around which a portion of the door elastic member is circularly wound, a first spring arm 392 extending from one end of the coiled portion 391, and a second spring arm 394 extending from the other end of the coiled portion 391. The door elastic member 390 may include a first coupling portion 393 extending at an angle from an end of the first spring arm 392, and a second coupling portion 395 extending at an angle from an end of the second spring arm 394.

The first coupling portion 393 may extend vertically from the end of the first spring arm 392, and the second coupling portion 395 may extend vertically from the end of the second spring arm 394.

The first coupling portion 393 may extend in a first direction from the end of the first spring arm 392, and the second coupling portion 395 may extend in a second direction opposite to the first direction from the end of the second spring arm 394. The first coupling portion 393 may extend in an upward direction from the end of the first spring arm 392, and the second coupling portion 395 may extend in a downward direction from the end of the second spring arm 394.

The first coupling portion 393 may be inserted into and coupled to the first support hole 365 formed in the hinge cover upper surface 360 described above. The second coupling portion 395 may be inserted into and coupled to at least one second support hole 275 (see FIG. 22) formed in the outer door 200.

As such, by having one end of the door elastic member 390 coupled to and supported by the upper hinge 300 and the opposite end of the door elastic member 390 coupled to the outer door 200, installation and replacement of the door elastic member 390 may be facilitated. In addition, by employing a torsion spring as the door elastic member 390, the opening operation of the outer door 200 may be performed smoothly.

The refrigerator 1 may include an elastic member cover 399 configured to cover the door elastic member 390. The elastic member cover 399 may be connected (e.g., coupled) to the hinge receiving portion 271 of the outer door 200. The elastic member cover 399 may protect the door elastic member 390 by preventing the door elastic member 390 from being exposed and preventing foreign matter from adhering to the door elastic member 390.

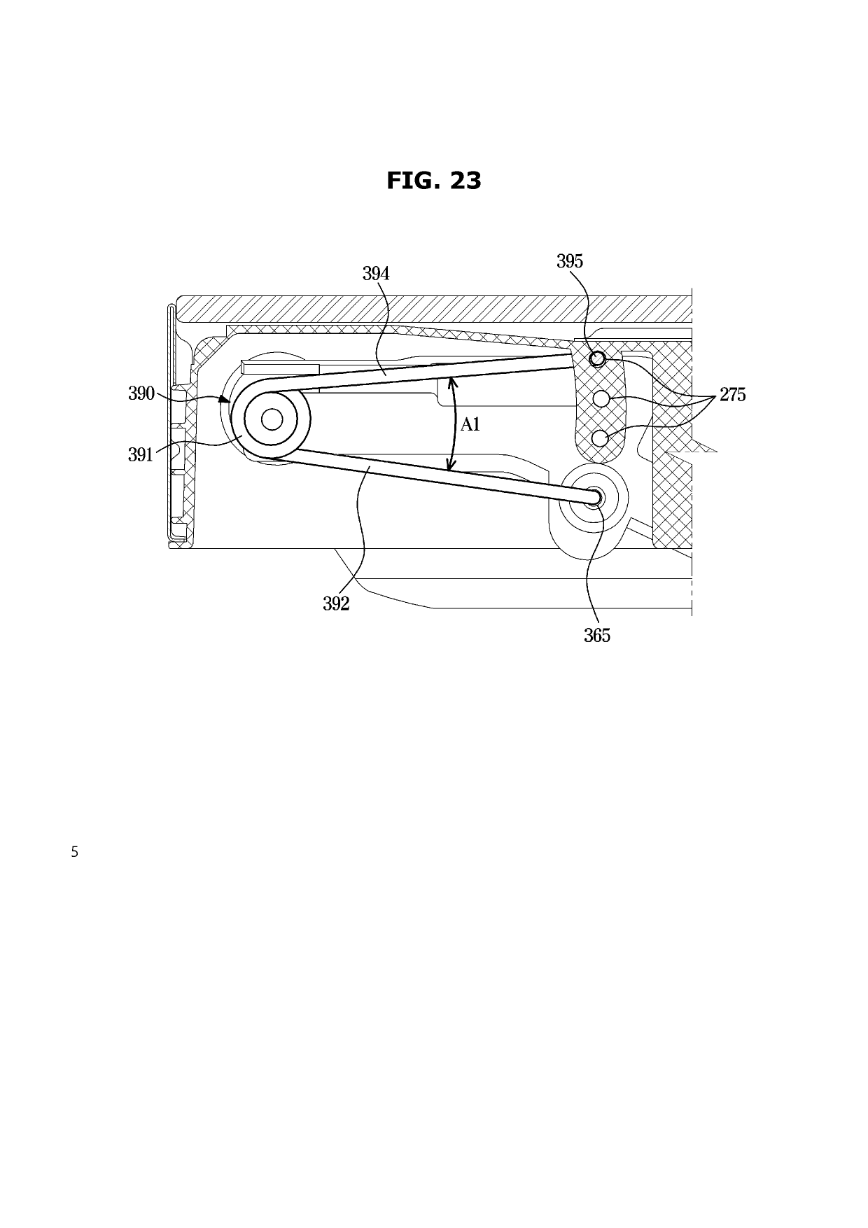

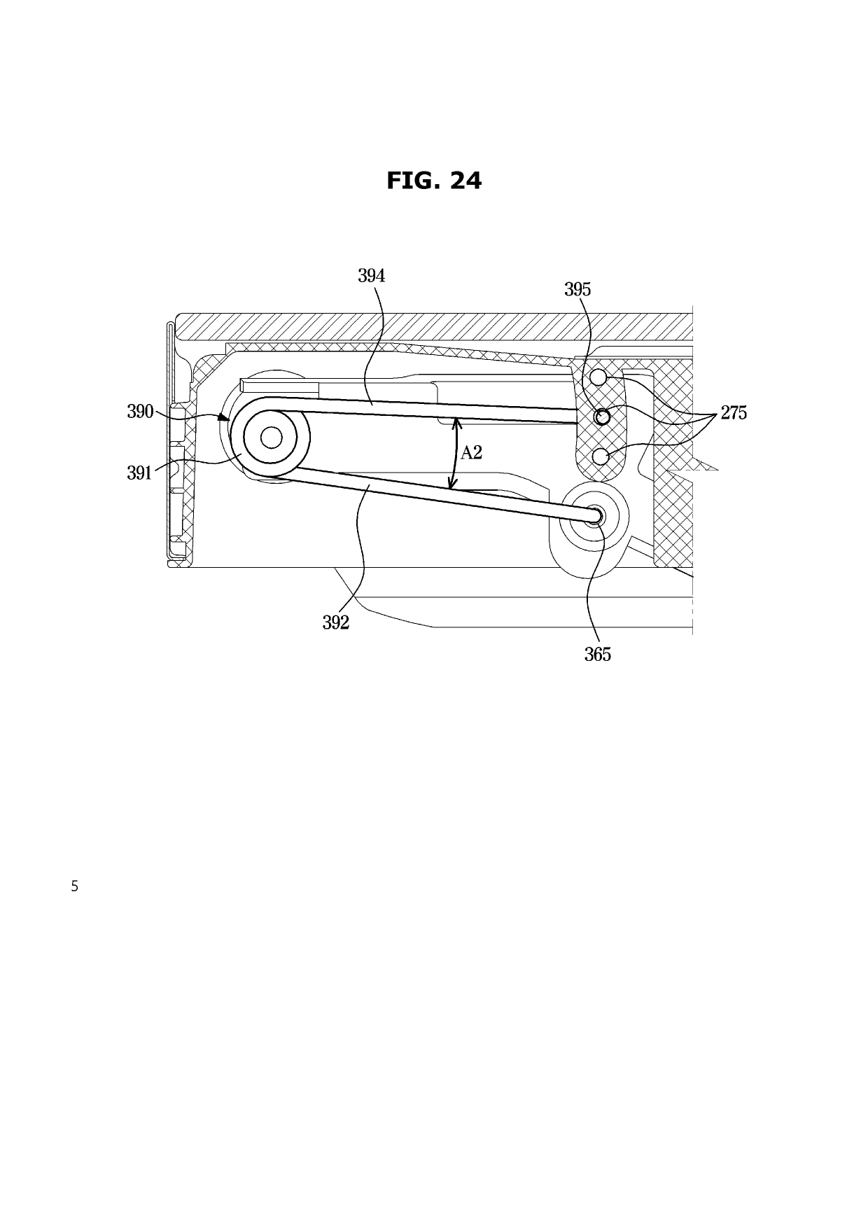

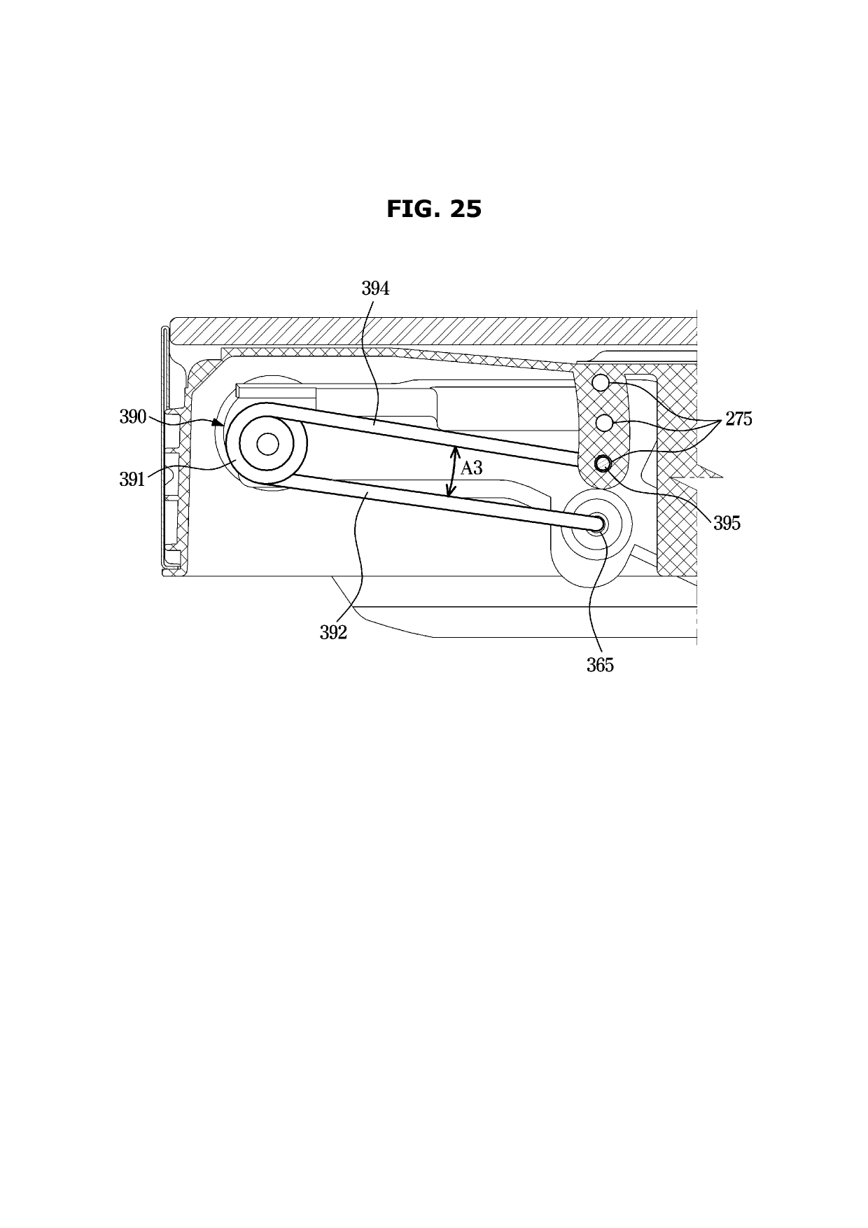

FIG. 22 is another view illustrating the coupling structure of the door elastic member according to an embodiment of the disclosure. FIG. 23 is a view illustrating a structure for adjusting an elastic force of the door elastic member according to an embodiment of the disclosure, showing the door elastic member in a state where an angle between a first spring arm and a second spring arm is an angle A1. FIG. 24 is a view illustrating a structure for adjusting an elastic force of the door elastic member according to an embodiment of the disclosure, showing the door elastic member in a state where the angle between the first spring arm and the second spring arm is an angle A2. FIG. 25 is a view illustrating a structure for adjusting an elastic force of the door elastic member according to an embodiment of the disclosure, showing the door elastic member in a state where the angle between the first spring arm and the second spring arm is an angle A3.

Referring to FIGS. 22 to 25, the at least one second support hole 275 may be provided in the hinge receiving portion 271 of the outer door 200. Specifically, the at least one second support hole 275 may be formed in an upper inner surface 272 of the hinge receiving portion 271.

Thus, as shown in FIGS. 21 and 22, the first coupling portion 393 bent downward of the door elastic member 390 may be inserted into and coupled to the first support hole 365 formed in the upper surface of the hinge cover 350, and the second coupling portion 395 bent upward of the door elastic member 390 may be inserted into and coupled to the upper inner surface 272 of the hinge receiving portion 271, so that the door elastic member 390 may be stably coupled between the upper hinge 300 and the outer door 200.

According to an embodiment of the disclosure, the second support hole 275 may be provided in plural. The plurality of second support holes 275 may be provided to adjust the elastic force of the door elastic member 390. That is, the elastic force of the door elastic member 390 may be adjusted depending on which of the plurality of second support holes 275 the second coupling portion 395 of the door elastic member 390 is coupled to.

The plurality of second support holes 275 may be arranged to be spaced apart from each other. An angle between the first spring arm 392 and the second spring arm 394 may vary depending on which of the plurality of second support holes 275 the second coupling portion 395 of the door elastic member 390 is coupled to, and accordingly, the elastic force of the door elastic member 390 may be adjusted.

In an example, as shown in FIGS. 23 to 25, three second support holes may be provided. However, two or more second support holes 275 may be sufficient, and there is no limitation on the number of second support holes 275.

As shown in FIG. 23, when the second coupling portion 395 of the door elastic member 390 is coupled to the second support hole 275 closest to the first support hole 365 among the plurality of second support holes 275, the angle between the first spring arm 392 and the second spring arm 394 may be the angle A1.

As shown in FIG. 24, when the second coupling portion 395 of the door elastic member 390 is coupled to the second support hole 275 in the intermediate of the plurality of second support holes 275, the angle between the first spring arm 392 and the second spring arm 394 may be the angle A2, which is less than the angle A1. When the angle between the first spring arm 392 and the second spring arm 394 is the angle A2, the elastic force of the door elastic member 390 may be greater than when the angle between the first spring arm 392 and the second spring arm 394 is the angle A1. Furthermore, because the elastic force of the door elastic member 390 is greater, the opening force or opening angle of the outer door 200 may be greater.

As shown in FIG. 25, when the second coupling portion 395 of the door elastic member 390 is coupled to the second support hole 275 that is farthest from the first support hole 365 among the plurality of second support holes 275, the angle between the first spring arm 392 and the second spring arm 394 may be the angle A3, which is less than the angle A2. When the angle between the first spring arm 392 and the second spring arm 394 is the angle A3, the elastic force of the door elastic member 390 may be greater than when the angle between the first spring arm 392 and the second spring arm 394 is the angle A2. Furthermore, because the elastic force of the door elastic member 390 is greater, the opening force or opening angle of the outer door 200 may be greater.

As such, as the angle between the first spring arm 392 and the second spring arm 394 becomes smaller, the elastic force of the door elastic member 390 may be larger, and accordingly, the opening force or opening angle of the outer door 200 may be larger.

With the configuration as described above, the elastic force of the door elastic member 390 may be easily adjusted, and accordingly, the opening force or opening angle of the outer door 200 may be easily set as needed. Furthermore, depending on the position of the second support hole 275, the outer door 200 may be configured to be open to a maximum opening angle, such as 135 degrees.

Although non-limiting example embodiments of the disclosure have been described above with reference to the accompanying drawings, the scope of the disclosure is not limited to these example embodiments; various modifications and variations that can be made by one having ordinary skill in the art are within the spirit and scope of the disclosure.

What is claimed is:

1. A refrigerator, comprising:
a main body comprising a storage compartment;
an inner door rotatably provided on a front side of the main body, the inner door including an opening;
an outer door rotatably provided on a front side of the inner door, the outer door configured to open or close the opening;
a hinge connecting the outer door and the inner door, the hinge configured to rotatably support the outer door; and
a door elastic member between the hinge and the outer door, the door elastic member configured to elastically bias the outer door in an opening direction of the outer door.

2. The refrigerator of claim 1, wherein the door elastic member comprises:
a first coupling portion at one end of the door elastic member, the first coupling portion connected to the hinge; and
a second coupling portion at an opposite end of the door elastic member, the second coupling portion connected to the outer door.

3. The refrigerator of claim 2, wherein
the hinge comprises a first support hole that is configured to receive the first coupling portion, and
the outer door comprises at least one second support hole that is configured to receive the second coupling portion.

4. The refrigerator of claim 3, wherein
the at least one second support hole is a plurality of second support holes, and
the plurality of second support holes are spaced apart from each other such that an elastic force of the door elastic member is adjusted depending on which of the plurality of second support holes the second coupling portion is inserted into.

5. The refrigerator of claim 4, wherein the door elastic member comprises a torsion spring , the torsion spring comprising:
a coiled portion;
a first spring arm extending from one end of the coiled portion; and
a second spring arm extending from an opposite end of the coiled portion.

6. The refrigerator of claim 5, wherein an angle between the first spring arm and the second spring arm is configured to be adjusted depending on which of the plurality of second support holes the second coupling portion is inserted into.

7. The refrigerator of claim 5, wherein
the first coupling portion extends at a first angle from the first spring arm at an end of the first spring arm, and
the second coupling portion extends at a second angle from the second spring arm at an end of the second spring arm.

8. The refrigerator of claim 7, wherein
the first coupling portion extends in a first direction at the end of the first spring arm, and
the second coupling portion extends in a second direction opposite to the first direction at the end of the second spring arm.

9. The refrigerator of claim 3, wherein the hinge comprises:
a hinge bracket comprising:
a door coupling portion connected to the inner door; and
a hinge arm extending from the door coupling portion toward the outer door,
a hinge pin at one end of the hinge arm, wherein the hinge pin forms an outer door rotation axis of the outer door, and
a hinge cover connected to the hinge bracket and covering the hinge bracket.

10. The refrigerator of claim 9, wherein the first support hole is in the hinge cover.

11. The refrigerator of claim 9, further comprising a reed switch configured to detect opening or closing of the outer door,
wherein the hinge cover comprises a switch mounting portion on which the reed switch is mounted.

12. The refrigerator of claim 11, wherein
the outer door comprises a hinge receiving portion that is recessed in a surface of the outer door, the hinge receiving portion configured to receive the hinge, and
the at least one second support hole is in an inner surface of the hinge receiving portion.

13. The refrigerator of claim 12, further comprising a magnet on an upper side of the hinge receiving portion, the magnet configured to interact with the reed switch.

14. The refrigerator of claim 12, further comprising an elastic member cover that is connected to the hinge receiving portion and covers the door elastic member.

15. The refrigerator of claim 1, further comprising a locking device configured to lock or unlock the outer door.
